(19) United States
(12) Patent Application Publication
(10) Pub. No.: US 2005/0198026 A1
(43) Pub. Date: Sep. 8, 2005

(54) Code, system, and method for generating concepts

(76) Inventors: Peter J. Dehlinger, Palo Alto, CA (US); Shao Chin, Felton, CA (US)

Correspondence Address: PERKINS COIE LLP, P.O. BOX 2168, MENLO PARK, CA, 94026, US

(21) Appl. No.: 11/049,811

(22) Filed: Feb. 2, 2005

Related U.S. Application Data
(60) Provisional application No. 60/541,675, filed on Feb. 3, 2004.

(51) Int. Cl. G06F 17/30

(52) U.S. Cl. 707/5

(57) ABSTRACT

Disclosed are a computer-readable code, system and method for generating candidate novel concepts in one or more selected fields. The system operates to generate strings of terms composed of combinations of word and optionally, word-group terms that are descriptive of concept elements in such field(s), and uses a genetic algorithm to find one or more high fitness strings, based on the application of a fitness metric which quantifies, e.g., the number occurrence of pairs of terms in texts in a selected library of texts. The highest- score string or strings are then applied in a database search to identify one or more pairs of primary and secondary texts whose terms overlap with those of a high fitness string.

This application claims priority to U.S. provisional patent application No. 60/541,675 filed on Feb. 3, 2005, which is incorporated herein in its entirety by reference.

### FIELD OF THE INVENTION

The present invention relates to a computer system, machine-readable code, and an automated method for manipulating texts, and in particular, for finding strings of terms and/or texts that represent a new concept or idea of interest.

### BACKGROUND OF THE INVENTION

Heretofore, a variety of computer-assist approaches have been proposed to aid human users in generating and/or evaluating new concepts. Computer- aided design (CAD) programs are available that assist engineers or architects in the design phase of engineering or architectural projects. Programs capable of navigating complex tree structures, such as chemical reaction schemes, use forward and backward chaining strategies to generate complex novel multi-step concepts, such as a series of reactions in a complex chemical synthesis. Computer modeling represents another approach to applying the computational power of computers to concept generation. This approach has been used successfully in generating and “evaluating” new drug molecules, using a large database of known compounds and reactions to generate and evaluate new drug candidates.

Despite these impressive approaches, computer-aided concept generation has been limited by the lack of practical methods for extracting and representing text-based concepts, that is, concepts that are most naturally expressed in natural-language texts, rather than a graphical or mathematical format that is more amenable to computer manipulation.

There is thus a need to provide computer-assist tool that can be used in generating novel concepts using text-based elements and objects as the building blocks for novel concepts.

### SUMMARY OF THE INVENTION

The invention includes, in one embodiment, a computer-assisted method for generating candidate novel concepts in one or more selected classes. The method includes first generating strings of terms composed of combinations of word and optionally, word-group terms that are descriptive of concept elements in such class(es). The method then operates to produce one or more high fitness strings by (1) mating the strings to generate strings with new combinations of terms; (2) determining a fitness score for each of the strings, (3) selecting those strings having the highest fitness score, and (4) repeating steps (1)-(3) until a desired fitness-score stability is reached. The fitness score for each of the strings is based on the application of a fitness metric which is related to one or both of the following: (a) for pairs of terms in the string, the number occurrence of such pairs of terms in texts in a selected library of texts; and (b) for terms in the string, and for one or more preselected attributes, attribute-specific selectivity values of such terms.

The string or strings with highest fitness score(s) may then be then used to identify one or more texts whose terms overlap with those of a high fitness string(s).

For use in generating combinations of concepts that represent candidate novel inventions in one or more selected fields, the one or more selected fields may be technology-related fields, and the selected library of texts and the identified texts may include patent abstracts or claims or abstracts from scientific or technical publications.

The step of generating strings of terms may include the steps (1) constructing a library of texts from a selected class or from word and/or word- group terms that identify or are associated with the selected class, (2) identifying word and/or word-group terms that occur with higher frequency in the library of texts from (1) than in a library of randomly selected texts, and (3) constructing combinations of terms from (2) to produce strings of terms of a given number of terms.

The step of mating the strings to generate strings with new combinations of terms; may include (1) selecting pairs of strings, and (2) randomly exchanging terms or groups of terms between the two strings in a pair. The step may further include randomly introducing a term substitution into a string of terms.

For determining fitness score for a string according to the number occurrence of groups of terms in texts in a selected library of concepts includes, the method may include, (1) for each pair of terms in the string, determining a term-correlation value related to the number occurrence of that pair of terms in a selected library of texts related to the one or more classes, and (2) adding the term-correlation values for all pairs of terms in the string. Step (1) may include includes accessing a matrix of term-correlation values which are related to the number occurrence of each pair of terms in a selected library of texts. In allow the method to accommodate new inventions, certain values in the term- correlation matrix may be varied to reflect the occurrence of corresponding pairs of terms in one or more selected concepts.

For use in determining fitness score for a string according to the selected values of one or more selected attributes, the method may include (1) for each term in the string, determining whether that term matches a term that is attribute- specific for a selected attribute; (2) assigning to each matched term, a selectivity value related to the occurrence of that term in the texts of a library of texts related to that attribute relative to the occurrence of the same term in one or more different libraries of texts, and (3) adding the selectivity values for all of the matched terms in the string.

For generating combinations of texts that represent candidate novel concepts related to two or more different selected classes, the step of generating strings may include constructing a library of texts related to each of the two or more selected classes, identifying, for each of the selected classes, a set of word and/or word-group terms that are descriptive of that class, constructing combinations of terms from each of the class-specific sets of terms to produce class-specific subcombination strings of terms, each with a given number of terms; and constructing combinations of strings from the class-specific subcombinations of strings. The step of producing high-fitness strings may include the steps of selecting pairs of strings, and randomly exchanging terms or segments of strings between the associated class-specific subcombinations of terms strings in a pair. The fitness score for a string may include, for each pair of terms within a class-specific subcombination of terms in the string, determining a term-correlation value related to the number occurrence of that pair of terms in a selected library of texts, and for each pair of terms within two class-specific subcombinations of terms in the string, determining a term- correlation value related to the number occurrence of that pair of terms in the same or a different selected libraries of texts, and adding the term-correlation values for all pairs of terms in the string.

The string selection steps may be repeated until the difference in a fitness score related to the fitness score or one or more of the highest-score strings between successive repetitions of the selection is less than a selected value. The step of identifying texts may include (1) searching a database of texts, to identify a primary group of texts having highest term match scores with a first subset of the terms in said string, (2) searching a database of texts, to identify a secondary group of texts having the highest term match scores with a second subset of said terms, where said first and second subsets are at least partially complementary with respect to the terms in said string, (3) generating pairs of texts containing a text from the primary group of texts and a different text from the secondary group of texts, and (4) selecting for presentation to the user, those pairs of texts that have highest overlap scores.

These score may be determined from one or more of: (a) overlap between descriptive terms in one text in the pair with descriptive terms in the other text in the pair; (b) overlap between descriptive terms present in both texts in the pair and said list of descriptive terms; (c) for one or more terms in one of the pairs of texts identified as feature terms, the presence in the other pair of texts of one or more feature-specific terms defined as having a higher rate of occurrence in a feature library composed in texts containing that feature term, d) for one or more attributes associated with the target invention, the presence in at least one text in the pair of attribute-specific terms defined as having a higher rate of occurrence in an attribute library composed in texts containing a word-and/or word-group term that is descriptive of that attribute, and (e) a citation score related to the extent to which one or both texts in the pair are cited by later texts.

In generating a plurality of different high-fitness strings, the method may further include, following the string selection step, of changing the fitness metric to produce a different fitness score for a given string, and repeating step string selection) one or more times to generate different highest-score strings.

For generating combinations of texts that represent candidate novel concepts related to a selected concept, the step of generating strings of terms may include (1) identifying word and optionally, word-group terms that are descriptive of the selected concept, (2) identifying word and optionally, word- group terms that are descriptive of one or more selected classes, and (3) constructing combinations of terms composed of (i) the terms identified in (1) and (ii) permutations of terms from (2) to produce strings of containing a given number of terms. The string selection step may include mating the strings to generate strings with (i) the same terms from (1) and new combinations of the terms from (2).

In another aspect, the invention includes a system for generating combinations of texts that represent candidate novel concepts in one or more selected fields. The system includes a computer, accessible by the computer (a) a database of texts that include texts related to the one or more selected concepts, and (b) a words-record database containing words and text identifiers related to those words, and a computer-readable code for carrying out the method above. The system may include, or generate, additional databases or records including a fields records, cross-term matrices, attribute records, and citation records. The computer-readable code forms yet another aspect of the invention.

These and other objects and features of the invention will become more fully apparent when the following detailed description of the invention is read in conjunction with the accompanying drawings.

### BRIEF DESCRIPTION OF THE DRAWINGS

FIGS. 1A and 1B show, in flow-diagram form, steps in for forming a new invention or concept by combining features from existing inventions, according to one invention paradigm, (1A) and an information graph showing the various information contributions made by an inventor in generating the invention (1B);

FIGS. 2A and 2B show, in flow-diagram form, steps for adapting a discovery to novel applications, according to a similar invention paradigm, (2A) and an information graph showing the various information contributions made by an inventor in generating the invention (2B);

FIG. 3 illustrates components of the system of the invention;

FIG. 4 shows, in flow diagram form, an overview of the operation of the method of the invention for generating new invention strings, and searching for and filtering pairs of references;

FIG. 5 is a flow diagram of steps for processing a natural-language text;

FIG. 6 is a flow diagram of steps for generating a database of processed text files;

FIG. 7 is a flow diagram of steps for generating a word-records database;

FIG. 8 illustrates a portion of two word records in a representative word- records database;

FIG. 9 is a flow diagram of system operations for generating, from a word- records database, a list of target words with associated selectivity values (SVs), and identifiers;

FIGS. 10A and 10B are flow diagrams of system operations for generating, from the list of target words and associated a word-records from FIG. 9, a list of target word pairs and associated selectivity values and text identifiers;

FIG. 11A is a flow diagram of system operations for calculating word inverse document frequencies (IDFs) for target words, and for generating a word-string vector representation of a target text, FIG. 11B shows an exemplary IDF function used in calculating word IDF values; and FIG. 11C shows how the search operation of the system may accommodate word synonyms;

FIG. 12 is a flow diagram of system operation for searching and ranking database texts;

FIG. 13 is a flow diagram of system operations for generating a search vector for a secondary search in accordance with the invention;

FIG. 14A is a flow diagram of feedback performance operations carried out by the system in refining a text-matching search, based on user selection of most pertinent texts;

FIG. 14B is a flow diagram of feedback performance operations carried out by the system in refining a text-matching search, based on user modification of descriptive term weights;

FIG. 14C is a flow diagram of feedback performance operations carried out by the system in refining a text-matching search, based on user selection of most pertinent text class;

FIG. 15 shows, in flow diagram form, the operation of the system in ranking pairs of combined texts based on term overlap;

FIG. 16 shows, in flow diagram form, the operation of the system in ranking pairs of combined texts based on term coverage;

FIG. 17A is a flow diagram of the operation of the system in generating an attribute library;

FIG. 17B is a flow diagram of the operation of the system in generating a dictionary of attribute terms from an attribute library;

FIG. 17C is a flow diagram of operations for identifying highest-ranked attribute-specific terms;

FIG. 17D shows, in flow diagram form, the operation of the system in ranking pairs of combined texts based on one or more selected attributes;

FIG. 18 shows, in flow diagram form, the operation of the system in ranking pairs of combined texts based on reference citation scores;

FIG. 19 shows, in flow diagram form, an overview of the method of the invention for generating concept strings related to one or more selected fields;

FIG. 20 shows in flow diagram form, the operation of the system for generating a cross-term matrix for a given class;

FIGS. 21A-21C are flow diagrams illustrating the steps in an evolutionary algorithm for generating most-fit term strings for a single class (21A), for carrying out term a mating operation between a pair of strings (2B), and for determining string fitness values of strings (21C);

FIGS. 22A and 22B are flow diagrams flow diagrams illustrating the steps in an evolutionary algorithm for finding most-fit term strings for coevolving strings representing two or more different classes (21A), and for determining combined string fitness values (22B);

FIG. 23 shows, in flow diagram form, the operation of the system in generating strings related to a concept disclosed in an abstract or patent claim and suggested by another selected field;

FIG. 24 is the graphical interface for the system directory;

FIG. 25 is the graphical interface for constructing new field libraries;

FIG. 26 is the graphical interface for constructing new attribute libraries.

FIG. 27 is the graphical interface for use in generating new strings of terms related to a given field, or two multiple fields;

FIG. 28 is the graphical interface for use in generating new strings of terms related to a given invention or claim;

FIG. 29 is the graphical interface for use in text searching to identify primary and secondary groups of texts; and

FIG. 30 is the graphical interface for use combining and filtering pairs of texts.

### DETAILED DESCRIPTION OF THE INVENTION

A. Definitions

“Natural-language text” refers to text expressed in a syntactic form that is subject to natural-language rules, e.g., normal English-language rules of sentence construction.

The term “text” will typically intend a single sentence that is descriptive of a concept or part of a concept, or an abstract or summary that is descriptive of a concept, or a patent claim of element thereof.

“Abstract” or “summary” refers to a summary, typically composed of multiple sentences, of an idea, concept, invention, discovery, story or the like. Examples, include abstracts from patents and published patent applications, journal article abstracts, and meeting presentation abstracts, such as poster-presentation abstracts, abstract included in grant proposals, and summaries of fictional works such as novels, short stories, and movies.

“Digitally-encoded text” refers to a natural-language text that is stored and accessible in computer-readable form, e.g., computer-readable abstracts or patent claims or other text stored in a database of abstracts, full texts or the like.

“Processed text” refers to computer readable, text-related data resulting from the processing of a digitally-encoded text to generate one or more of (i) non- generic words, (ii) wordpairs formed of proximately arranged non-generic words, (iii) word-position identifiers, that is, sentence and word-number identifiers.

A “verb-root” word is a word or phrase that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language text that are not descriptive of, or only non-specifically descriptive of, the subject matter of the text. Examples include prepositions, conjunctions, pronouns, as well as certain nouns, verbs, adverbs, and adjectives that occur frequently in texts from many different fields. “Non-generic words” are those words in a text remaining after generic words are removed.

A “word group” is a group, typically a word pair, of non-generic words that are proximately arranged in a natural-language text. Typically, words in a word group are non-generic words in the same sentence. More typically they are nearest or next-nearest non-generic word neighbors in a string of non-generic words, e.g., a word string.

Words and optionally, words groups, usually encompassing non-generic words and wordpairs generated from proximately arranged non-generic words, are also referred to herein as “terms”.

“Class” or “field” refers to a given technical, scientific, legal or business field, as defined, for example, by a specified technical field, or a patent classification, including a group of patent classes (superclass), classes, or sub-classes. A class may have its own taxonomic definition, such as a patent class and/or subclass, or a group of selected patent classes, i.e., a superclass. Alternatively, the class may be defined by a single term, or a group of related terms. Although the terms “class” and “field” may be used interchangeably, in general, the term “class” will generally will refer to a relatively narrow class of texts, e.g., all texts in a contained in a patent class or subclass, or related to a particular concepts, and the term “field,” to a group of classes, e.g., all classes in the general field of biology, or chemistry, or electronics.

“Library of texts in a class” or “library of texts in a field” refers to a library of texts (digitally encoded or processed) that have been preselected or flagged or otherwise identified to indicate that the texts in that library relate to a specific class or field. For example, a library may include patent abstracts from each of up to several related patent classes, from one patent class only, or from individual subclasses only. A library of texts typically contains at least 100 texts, and may contain up to 1 million or more.

A “class-specific selectivity value” or a “filed-specific selectivity value” for a word or word-group term is related to the frequency of occurrence of that term in a library of texts in one class or field, relative to the frequency of occurrence of the same term in one or more other class or field libraries of texts, e.g., a library of texts selected randomly without regard to class.

“Frequency of occurrence of a term (word or word group) in a library” is related to the numerical frequency of the term in the library of texts, usually determined from the number of texts in the library containing that term, per total number of texts in the library or per given number of texts in a library. Other measures of frequency of occurrence, such as total number of occurrences of a term in the texts in a library per total number of texts in the library, are also contemplated.

A “function of a selectivity value” a mathematical function of a calculated numerical-occurrence value, such as the selectivity value itself, a root (logarithmic) function, a binary function, such as “+” for all terms having a selectivity value above a given threshold, and “−” for those terms whose selectivity value is at or below this threshold value, or a step function, such as 0, +1, +2, +3, and +4 to indicate a range of selectivity values, such as 0 to 1, >1-3, >3-7, >7-15, and >15, respectively. One preferred selectivity value function is a root (logarithm or fractional exponential) function of the calculated numerical occurrence value. For example, if the highest calculated-occurrence value of a term is X, the selectivity value function assigned to that term, for purposes of text matching, might be X^{1/2} or X^{1/2.5}, or X^{1/3}.

“Feature” refers to some a basic element, quality or attribute of a concept. For example, where the concept is an invention, the features may related to (i) the problem to be solved or the problem to be addressed by the invention, (ii) a critical method step or material for making the invention, or (iii) to an application or use of the invention. Where the concept is a scientific or technical concept, the features may be related to (i) a discovery underlying the concept, (ii) a principle underlying the concept, and (iii) a critical element or material needed in executing the concept. Where the concept is a story, e.g., a fictional account, the features may be related to (i) a basic plot or motif, (ii) character traits of one or more characters, and (iii) setting.

An “attribute” refers to a feature related to some quality or property or advantage of the concept, typically one that enhances the value of the concept. For example, in the case of an inventive concept, an attribute feature might be related to an unexpected result or an unsuggested property or advantage. In the case of a scientific concept, the property might be related to widespread acceptance, or value to other researchers. For a story concept, an attribute feature might be related to popular appeal or genre.

A “descriptor” refers to a feature or an attribute.

A “descriptor library of texts” or “descriptor library” refers to a collection of texts in a database of texts in which all of the texts contain one or more terms related to a specified descriptor, e.g., an attribute in an attribute library or a feature in a feature library. Typically, the descriptor (feature or attribute) is expressed as one or more words and/or word pairs, e.g., synonyms that represent the various ways that the particular descriptor might be expressed in a text. A descriptor attribute library is typically formed by searching a database of texts for those texts that contain a word or word group related to the descriptor, and is thus a subset of the database.

A descriptor “selectivity value”, that is, an attribute or feature selectivity value of a term in a descriptor library, is related to the frequency of occurrence of that term in the associated library, relative to the frequency of occurrence of the same term in one or more other libraries of texts, typically one or more other non- attribute or non-feature libraries, such as a library of texts randomly selected without regard to descriptor. The measure of frequency of occurrence of a term is preferably the same for all libraries, e.g., the number of texts in a library containing that term. The descriptor selectivity value of a given term for a given field is typically determined as the ratio of the percentage texts in the descriptor library that contain that term, to the percentage texts in one or more other, preferably unrelated libraries that contain the same term. A descriptor selectivity value so measured may be as low as 0.1 or less, or as high as 1,000 or greater. The descriptor selectivity value of a term indicates the extent to which that term is associated with that descriptor.

A term is “descriptor-specific,” e.g., “attribute-specific” or “feature specific” for a given attribute or feature (descriptor) if the term has a substantially higher rate of occurrence in a descriptor library composed in texts containing a word- and/or word-group term that is descriptive of that preselected descriptor than the same term has in a library of texts unrelated to that descriptor, e.g. a library of texts randomly selected without regard to the descriptor. A typical measure of a term's descriptor's specificity is the term's descriptor selectivity value. A “group of texts” or “combined group of texts” refers to two or more texts, e.g., summaries, typically one text from each of two or more different features libraries, although texts from the same library may also be combined to form a group of texts.

An “extended group of texts” refers to groups of texts that are themselves combined to produce combinations of combined groups of texts. For example, a group of texts composed of texts A, B may be combined with a group of texts c, d, to form an extended group of texts A, B, C, D.

A “text identifier” or “TID” identifies a particular digitally encoded or processed text in a database, such as patent number, assigned internal number, bibliographic citation or other citation information.

A “library identifier” or “LID” identifies the field, e.g., technical field patent classification, legal field, scientific field, security group, or field of business, etc. of a given text.

“A word-position identifier” of “WPID” identifies the position of a word in a text. The identifier may include a “sentence identifier” or “SID” which identifies the sentence number within a text containing a given word or word group, and a “word identifier” or “WID” which identifiers the word number, preferably determined from distilled text, within a given sentence. For example, a WPID of 2-6 indicates word position 6 in sentence 2. Alternatively, the words in a text, preferably in a distilled text, may be number consecutively without regard to punctuation.

A “database” refers to one or more files of records containing information about libraries of texts, e.g., the text itself in actual or processed form, text identifiers, library identifiers, classification identifiers, one or more selectivity values, and word-position identifiers. The information in the database may be contained in one or more separate files or records, and these files may be linked by certain file information, e.g., text numbers or words, e.g., in a relational database format.

A “text database” refers to database of processed or unprocessed texts in which the key locator in the database is a text identifier. The information in the database is stored in the form of text records, where each record can contain, or be linked to files containing, (i) the actual natural-language text, or the text in processed form, typically, a list of all non-generic words and word groups, (ii) text identifiers, (iii) library identifiers identifying the library to which a text belong, (iv) classification identifiers identifying the classification of a given text, and/or (v), word-position identifiers for each word. The text database may include a separate record for each text, or combined text records for different libraries and/or different classification categories, or all texts in a single record. That is, the database may contain different libraries of texts, in which case each text in each different-field library is assigned the same library identifier, or may contain groups of texts having the same classification, in which case each text in a group is assigned the same classification identifier.

A “word database” or “word-records database” refers to a database of words in which the key locator in the database is a word, typically a non-generic word. The information in the database is stored in the form of word records, where each record can contain, or be linked to files containing, (i) selectivity values for that word, (ii) identifiers of all of the texts containing that word, (iii), for each such text, a library identifier identifying the library to which that text belongs, (iv) for each such text, word-position identifiers identifying the position(s) of that word in that text, and (v) for each such text, one or more classification identifiers identifying the classification of that text. The word database preferably includes a separate record for each word. The database may include links between each word file and linked various identifier files, e.g., text files containing that word, or additional text information, including the text itself, linked to its text identifier. A word records database may also be a text database if both words and texts are separately addressable in the database.

A “correlation score” as applied to a group of texts refers to a value calculated from the function related to linking terms in the texts. The correlation score indicates the extent to which two or texts in a group of texts are related by common terms, common concepts, and/or common goals. A correlation score may be corrected, e.g., reduced in value, for other factors or terms.

A “concept” refers to an invention, idea, notion, storyline, plot, solution, or other construct that can be represented (expressed) in natural-natural text or as a string of terms.

B. Paradigm for Concept Generation

New concepts can arise from a variety of sources, such as the discovery of new elements or principles, the discovery of interesting or unsuggested properties or features or materials or devices, or the rearranging of elements in new ways to perform novel functions or achieve novel results.

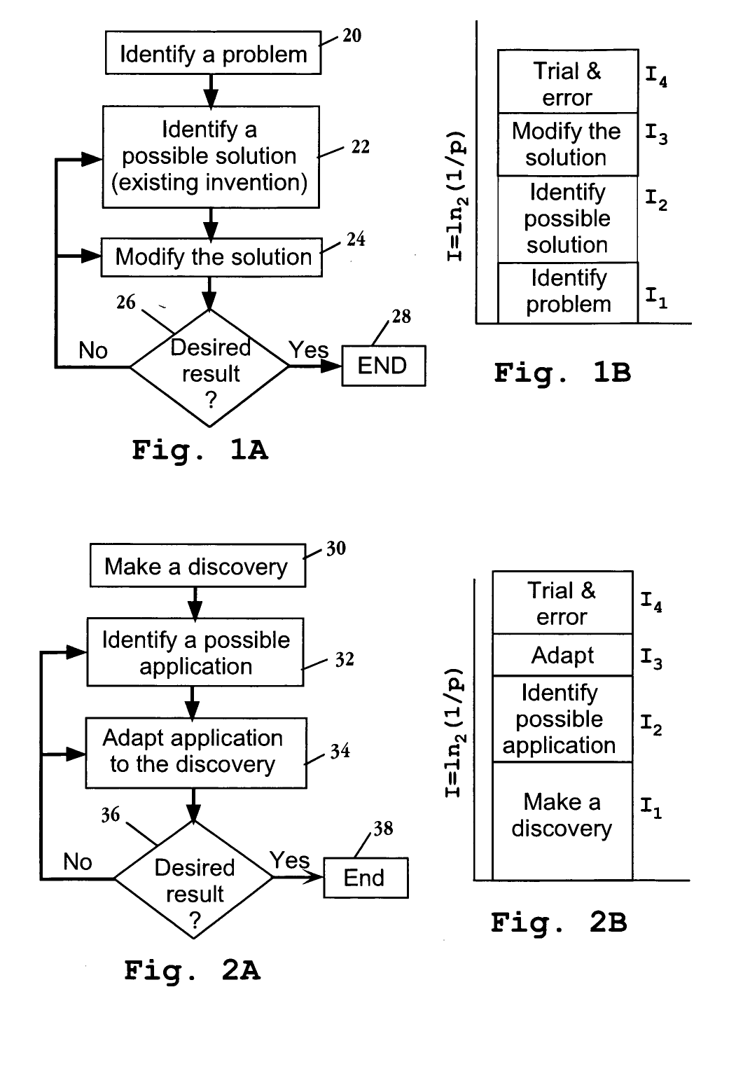

An invention paradigm that enjoys wide currency is illustrated, in very general form in the flow diagram shown in FIG. 1A. This paradigm has particular relevance for the type of invention in which two or more existing inventions (or concepts) are combined to solve a specific problem. The user first selects a problem to be solved (box 20). The problem may be one of overcoming an existing limitation in the prior art, improving the performance of an existing invention, or achieving an entirely novel result. As a first step in solving the problem, the user will try to find, among all possible solutions, e.g., existing inventions, one primary reference or invention that can be modified or otherwise adapted to solve the problem at hand. Typically, the inventor will approach this task by drawing on experience and personal knowledge to identify a possible existing solution that represents “a good place to start” in solving the problem.

Once this initial starting point has been identified, the user attempts to adapt the existing, selected invention to the problem at hand. That is, the inventor modifies the solution (box 24) in its structural or operational features, so that the selected invention is capable of solving the new problem. In performing this step, the inventor is likely to draw on personal knowledge of the field of the invention, to “discover” one or more possible modifications that would solve the problem at hand.

Typically, the user will repeat the selection/modifications steps above, either by actual or conceptual trial and error, until a good solution is found, indicated by logic box 26. When the desired result is achieved, the inventing is at an end (box 38), even though additional work may remain in refining or commercializing the invention.

The bar graph in FIG. 1B shows typical information contributions at each stage of the inventing process. The measure of information used here is taken from information theory, which expresses information in the form I=In₂(1/P), where P is the probability that a particular event will be selected. For example, in the step of identifying the problem to be solved, it is assumed that the inventor selects the problem out of N possible problems. The probability P of selecting this problem is then 1/N, and the information needed to make this selection I₁=In₂N. As can be appreciated, this measure of information reflects the number of “yes-no” questions would be required to pick the desired solution out of N possible solution. The actual amount of information needed to identify a given problem (I₁ in FIG. 1B) may be relatively trivial for an obvious or widely recognized problem, or might be high for a previously unidentified, or otherwise nonobvious new problem.

The information I₂ needed to identify an initial “starting-point” solution is similarly determined as the In₂ of the number of different existing inventions or concepts one might select from to form the starting point of the solution. Since the number of possible solutions tends to be quite large as a rule, the information contribution of this step is indicated as being relatively high. The graph similarly shows the information contributions I₃ and I₄ for modifying the starting-point solution and the trail and error phase of the invention. In each case, the information contribution reflects the number of possible choices or selections needed to arrive, ultimately, at a desired solution.

If two or more separate events, such as the various inventive activities just described, have individual probabilities of, say, P₁ and P₂, the total probability of the combined event is just their product, e.g., P₁*P₂. A useful property of a logarithm function as a measure of information is that the information contributions making up the invention are additive, since In N₁*N₂=In N₁+In N₂. In the present case, the information contributions from P₁, P₂, P₃, and P₄ of making a combination type invention can be expressed as the sum of individual information contributions, that is I₁+I₂+I₃+I₄, as shown in FIG. 1B.

Another general type of invention arises from new discoveries, such as observations on natural phenomena, or data generated by systematic experimental studies. Examples that one might mention are: the discovery of a material with novel properties, the discovery of novel drug interactions in biological systems, a discovery concerning the behavior of fluids under novel flow conditions, a novel synthetic reaction, or the observation a novel self- assembling property of a material, among many examples. In each case, the discovery was unpredictable from then-known laws of nature, or explainable only with the benefit of hindsight.

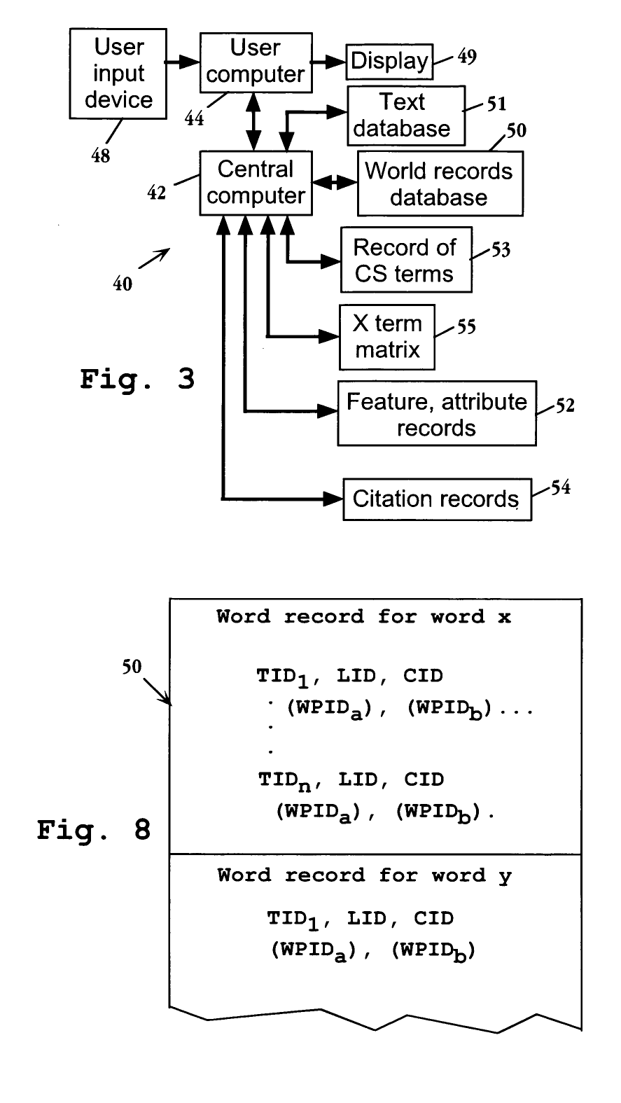

When a discovery is made, one typical looks for ways of applying the discovery to real-world problems. An invention paradigm that may be useful in examining the inventive activity that takes place between a discovery and a fully realized application is shown in flow-diagram form in FIG. 2A. Once the discovery is made (box 30), the inventor looks for possible applications, meaning references or inventions that might be able to profit from the discovery. Sometimes, as in the case of a novel drug interaction with a biological system, one or more applications will be readily apparent to the discoverer. In other cases, e.g., the discovery of a self-assembly property of a material or molecule, possible applications may be relatively obscure. In either case, once one or more possible applications are identified (box 32), the inventor must then adapt the discovery to the application (or adapt the application to the discovery), as at 34.

As examples of such an adaptation, an element or material with a newly discovered property may be substituted for an existing element or material, to enhance the performance of an existing invention; an existing device may be reduced in scale to realize newly-discovered fluid-flow property; the pressure or temperature of operation of an existing method or device may be varied to realize a newly-discovered property or behavior; or an existing compound developed as a novel therapeutic agent, based on a newly discovered product. Once a possible application is identified, the inventor may need to modify or adapt the application to the discovery (or the discovery to the application), requiring the selection of yet another part of the solution.

As in the first paradigm, the user will typically repeat the selection/modifications steps, either by actual or conceptual trial and error, until a good solution is found, indicated by logic box 36, and when a desired application is developed, the inventing may be complete, or the inventor can repeat the process anew for yet further applications.

The bar graph in FIG. 2B shows typical information contributions at each stage of the inventing process. Since the discovery itself is typically a low- probability event, made from a very large collection N of possible discoveries, the information I₁ required for the discovery is typically the largest information component. Each of the remaining activities, in turn, requires selection of a “solution” out of a plurality of possible choices, each being expressed as an information component I₂, I₃, and I₄, as indicated in the figure, where the total information required to make the discovery and apply it successfully is the sum of the information components.

This discussion of human mental and experimental activities required in concept generation, e.g., inventing, will set the stage for the discussion below on machine-assisted invention. In particularly, the system and method to be described are intended to assist in certain of the invention tasks outlined above, with the result that the human inventor can reach the same or better end point with a substantially lower information input. The information difference is, as will be seen, supplied by various text-mining operations carried out by the system and designed to (i) identify descriptive word and word-group terms in natural- language texts, (ii) identify field-specific terms; (iii) generate concept-related strings of terms based on cross-term frequencies and/or attribute-specific terms, (iv) locate pertinent texts, and (v) generate pairs of texts based on various types of statistically significant (but generally hidden) correlations between the texts.

Finally, it will be appreciated the notion of human invention as a series of probabilistic events will apply to many other forms of human creative activity. For example, a scientist might naturally employ one or both of the invention paradigms above to design experiments, or test hypotheses, or apply new discoveries. Similarly, a writer of fiction might start off with a general plot, and fill in details of the plot by piecing together plots or character actions from a variety of different sources.

C. System and Method Overview

FIG. 3 shows the basic components of a system 40 for assisting a user in generating new concepts in accordance with the present invention. A central computer or processor 42 receives user input and user-processed information from a user computer 44, or the program and data can be cited on a single user computer, which then becomes the central processor. The user computer has a user-input device 48, such as a keyboard, modem, and/or disc reader, by which the user can enter target text, refine search results, and guide certain correlation operations. A display or monitor 49 displays word, wordpair, search, and classification information to the user. The system further includes a text database 51 and a words-records database 50 which are accessed by the computer during various phases of system operation. The nature of text database and word-records database are described above.

The system is designed to generate additional records and data files, including records of class-specific terms, such as record 53, cross-term matrices, such as matrix 55, attribute records, such as records 52, and citation records 54. Once generated these records and files may be stored for access by the computer during system operation, as indicated. A class records include class-specific terms for each of one or more selected classes. A cross-term matrix file includes a matrix of cross-term values for top class-specific terms in a given class, or top class- specific terms in two or more selected classes. As will be seen, the matrix terms may be altered during operation to suppress matrix values for already selected pairs of terms, and to accommodate new invention data. The attribute records include attribute-specific terms for each of one or more selected attributes, e.g., properties or qualities that are desired for a new concept. The citation records includes, for each TID, i.e., identified text in the system, a normalized citation score indicating the frequency with which that text has been cited in subsequent texts in the database.

It will be understood that “computer,” as used herein, includes both computer processor hardware, and the computer-readable code that controls the operation of the computer to perform various functions and operations as detailed below. That is, in describing program functions and operations, it is understood that these operations are embodied in a machine-readable code, and this code forms one aspect of the invention.

In a typical system, the user computer is one of several remote access stations, each of which is operably connected to the central computer, e.g., as part of an Internet or intranet system in which multiple users communicate with the central computer. Alternatively, the system may include only one user/central computer, that is, where the operations described for the two separate computers are carried out on a single computer, as noted above.

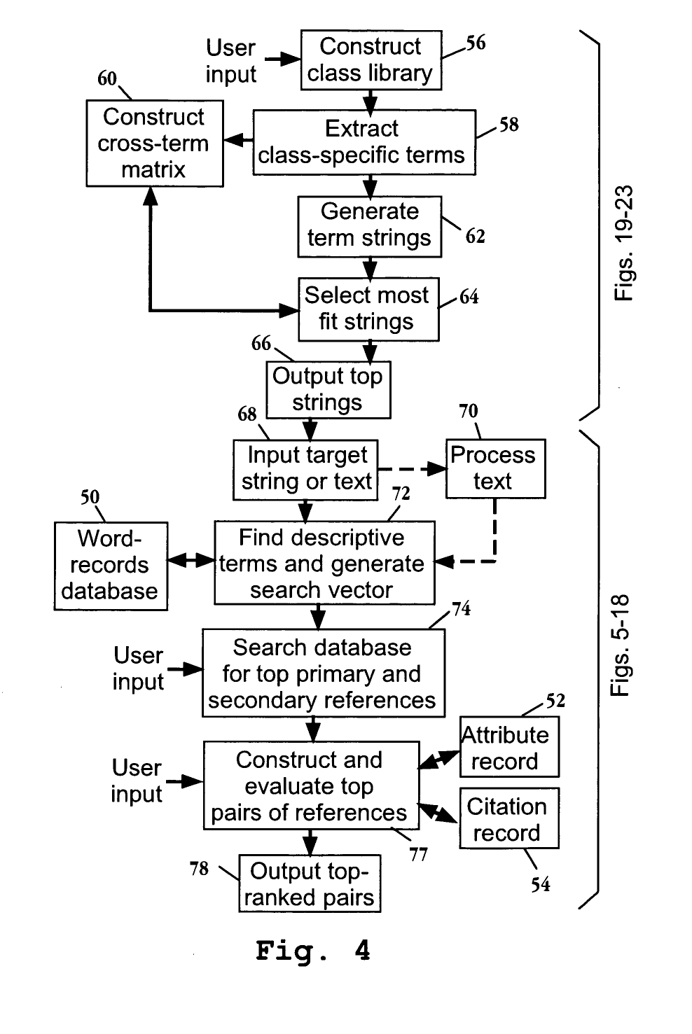

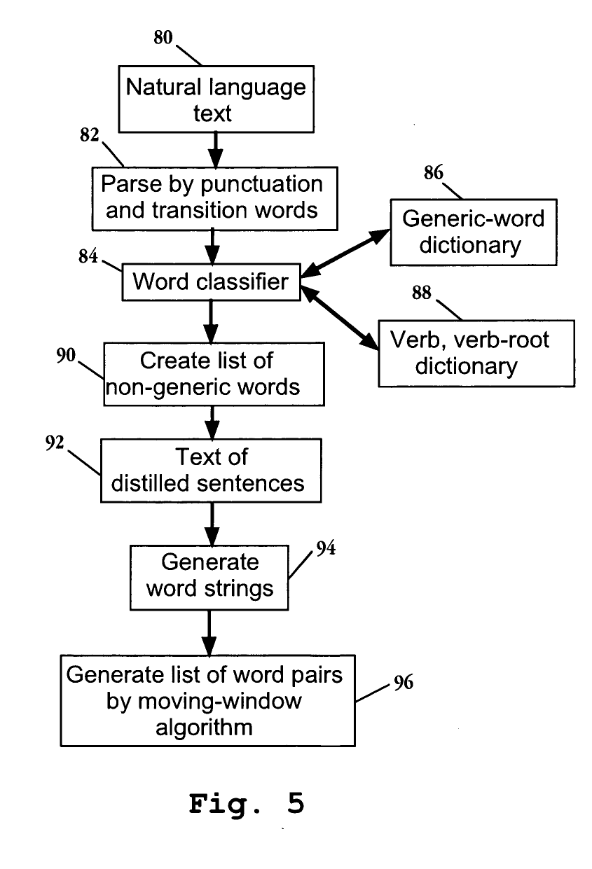

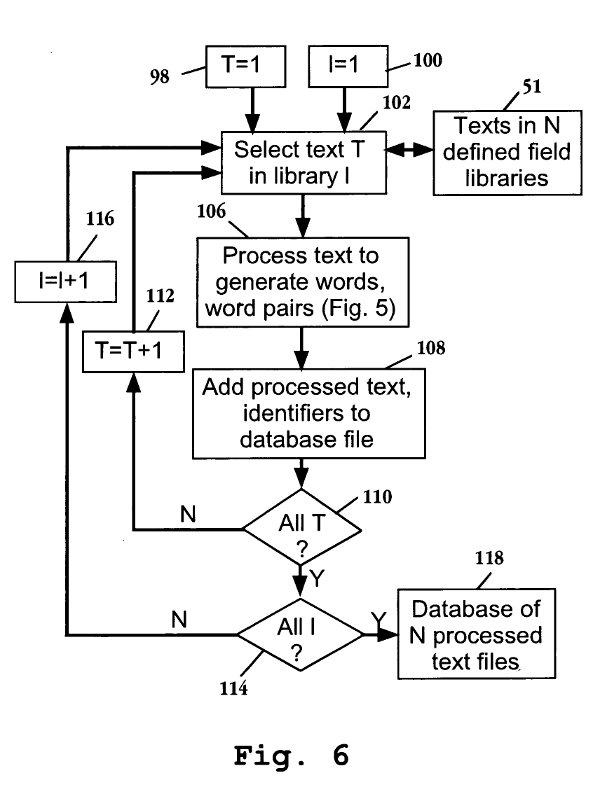

FIG. 4 is an overview flow diagram of operations carried out by the system of the invention for generating new invention strings, to be detailed below with reference to FIGS. 19-23 and for finding texts corresponding to the strings and filtering pairs of texts according to one or more of several selected criteria, to be detailed below with reference to FIGS. 5-18.

Considering first the system operation for generating strings of terms, the user inputs one or more terms related to a selected class, e.g., technical class. These terms are typical terms that are likely to be found in texts related to the selected field. Thus, for example if one selected the field of “nanotech fabrication”, the terms entered might be “nanoscale lithography,” “nanolithography,” “dip pen lithography,” “e-beam lithography,” “nanosphere liftoff lithography,” “controlled-feedback lithography,” “microimprint lithography,” and “nanofabrication.” Alternatively, the user might input a recognized class, such as a patent-office class or subclass from which identified texts related to that class can be identified.

The input terms or identified class are used by the program to construct a class library (box 56), by accessing the text database, and identifying all texts in the database that contain one of the class-descriptive input terms, or all texts given a selected classification.

The program then “reads” all of the texts in the class library, extracts non- generic terms, in this case, words and word-pairs, and finds the “class-specific selectivity value” for each term. This value is related to the frequency of occurrence of that term in a library of texts in the selected field, relative to the frequency of occurrence of the same term in one or more other libraries of texts in a different classes, typically texts randomly chosen without regard to class. From among the identified class-specific (CS) terms, the program extracts the top terms from the list, as at 58. For example, the program may select the top 100 words and top 100 word-pairs with the highest class-specific selectivity values.

Each pair of class-specific terms selected at 58 has a co-occurrence value related to the frequency of occurrence of that pair of terms in all of the texts of a given library of texts, typically the texts that span a large number of different classes, or alternatively, texts from the selected-class library only. For example, if the term “fabrication” and “acid etching” were found is 500 texts in a library of texts spanning several classes, those two terms would have a co-occurrence value related to 500. This actual co-occurrence number may be, for example, a logarithmic function of the actual occurrence number, e.g., log₁₀500. The co- occurrence or cross-term values for all pairs of texts extracted at 58 is placed in a cross-term (X-term) matrix 60.

Guided by user input relating to string length and type of string (see below), the program constructs at 62 strings composed of random groups (strings or lists) of class-specific terms from 58. These strings are then selected by a genetic algorithm that (i) mates pairs of strings with one another, evaluates a fitness value of each string based on the application of a fitness metric which is related to one or both of the following: (a) for pairs of terms in the string, the number occurrence of such pairs of terms in texts in a selected library of texts; and (b) for terms in the string, and for one or more preselected attributes, attribute-specific selectivity values of such terms. The strings with the highest fitness score are selected, and the mating and selecting process is repeated until string fitness values converge to some asymptotic value (box 64). The program outputs the highest-values of these strings, as at 66.

A selected string from the 66 becomes the input to the portion of the program that carries out searching and filtering operations to find one or more, and typically a pair of, references that has the closest concept overlap (based on word and wordpair overlap) with the input string. Alternatively, if the string-generating function of the system is not used, the input might be a natural-language text describing a desired invention or concept, requiring an additional step of processing the text to generate a string of terms, as at 70.

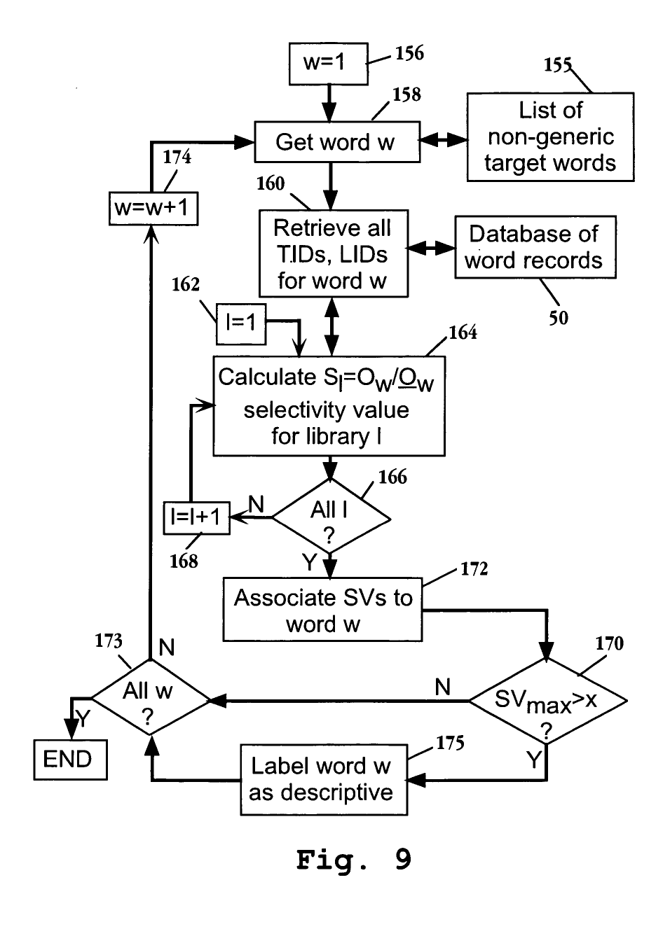

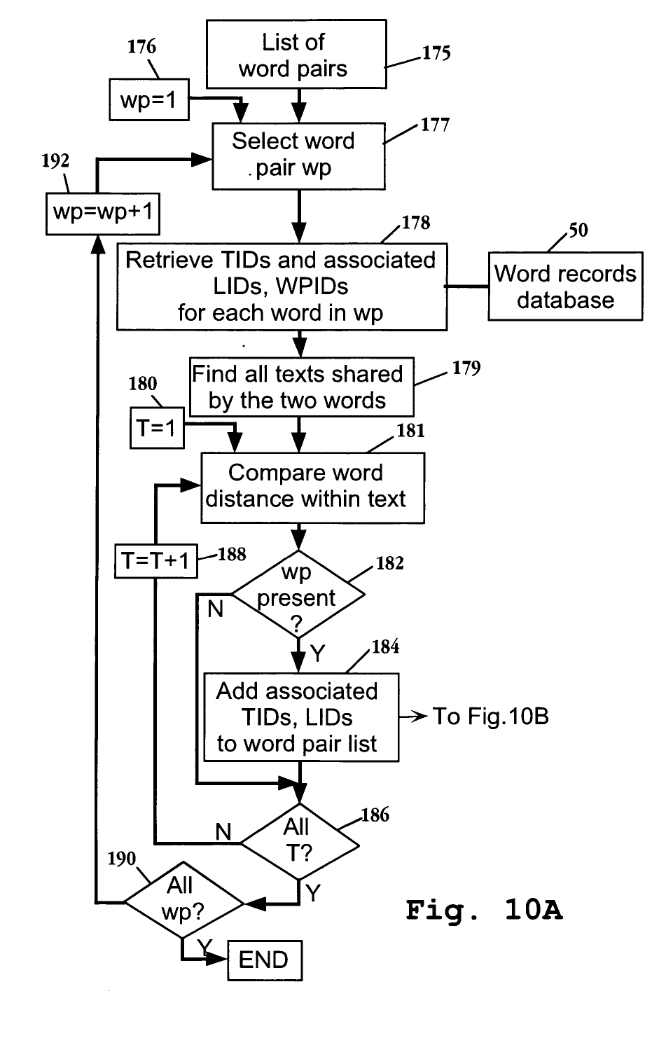

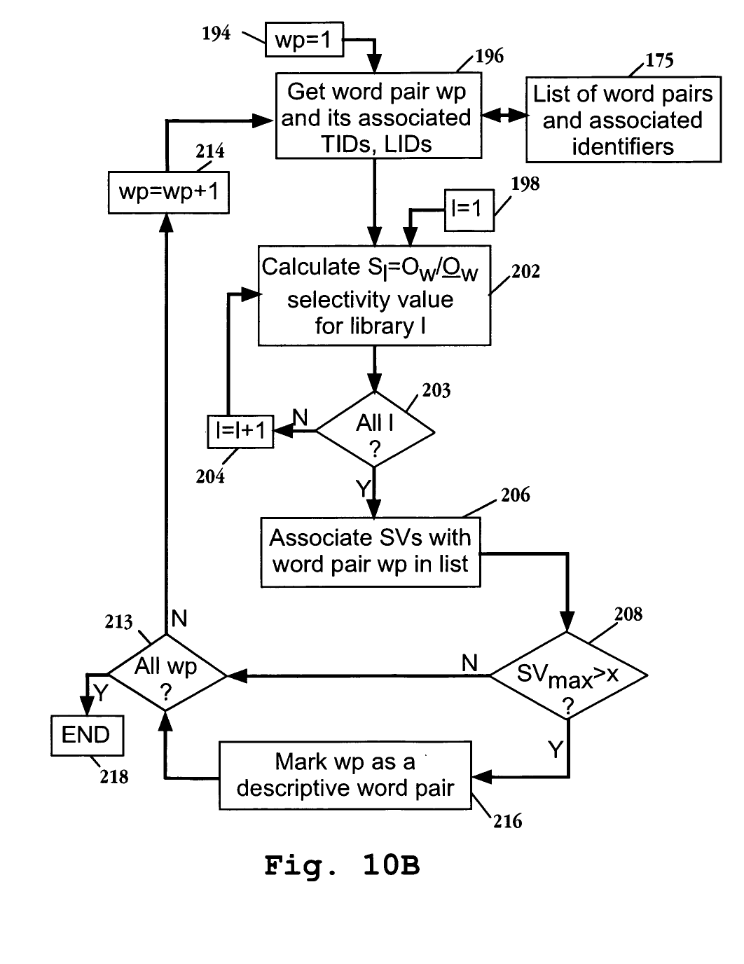

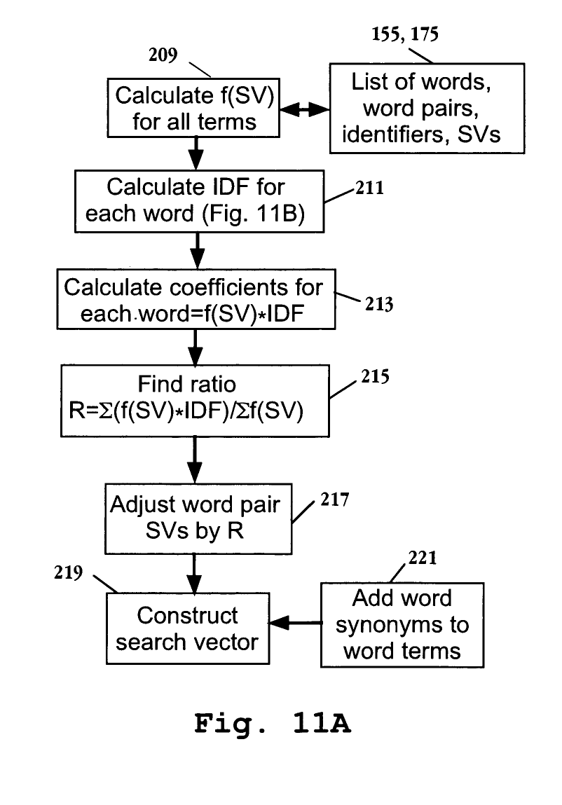

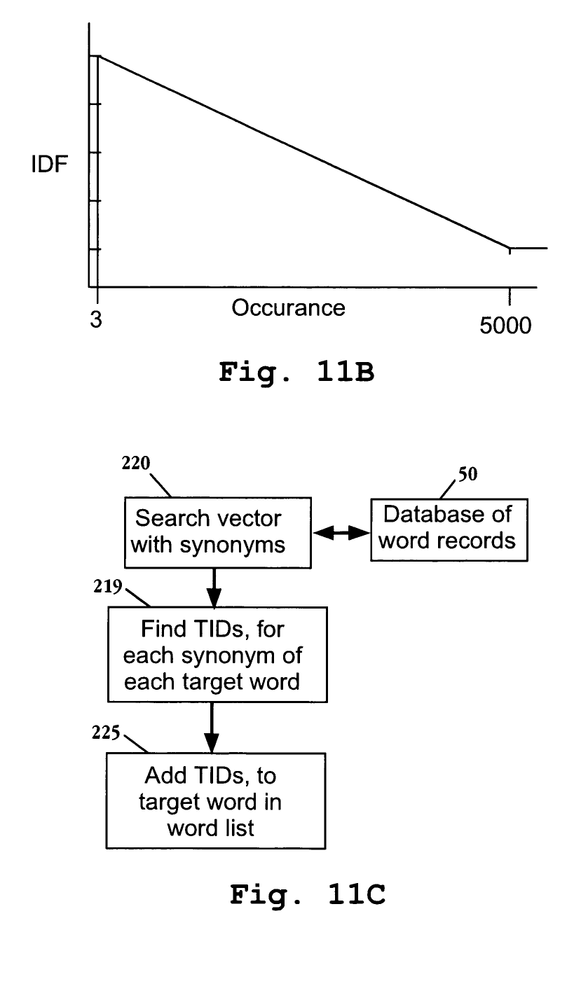

Whether the input is a natural-language text or string of terms, the program identifies a term as “descriptive” if its rate of occurrence in a library of texts in one class, relative to its occurrence in a library of texts in another class or group of classes (the term's selectivity value) is above a given threshold value, as described below with respect to FIG. 9, for descriptive words, and in FIGS. 10A and 10B, for descriptive word pairs. As part of the process of identifying descriptive terms, the program accesses word-records database 50 to determine the rate of occurrence of each in different classes of texts (typically supraclasses pertaining to broad areas of technology). The program now constructs a vector representing the descriptive terms in the target as a sum of terms (the coordinates of the vector), where the coefficient assigned to each term is related to the associated selectivity value of that term, and in the case of a word term, may also be related to the word's inverse document frequency, as described below with respect to FIGS. 11A-11C.

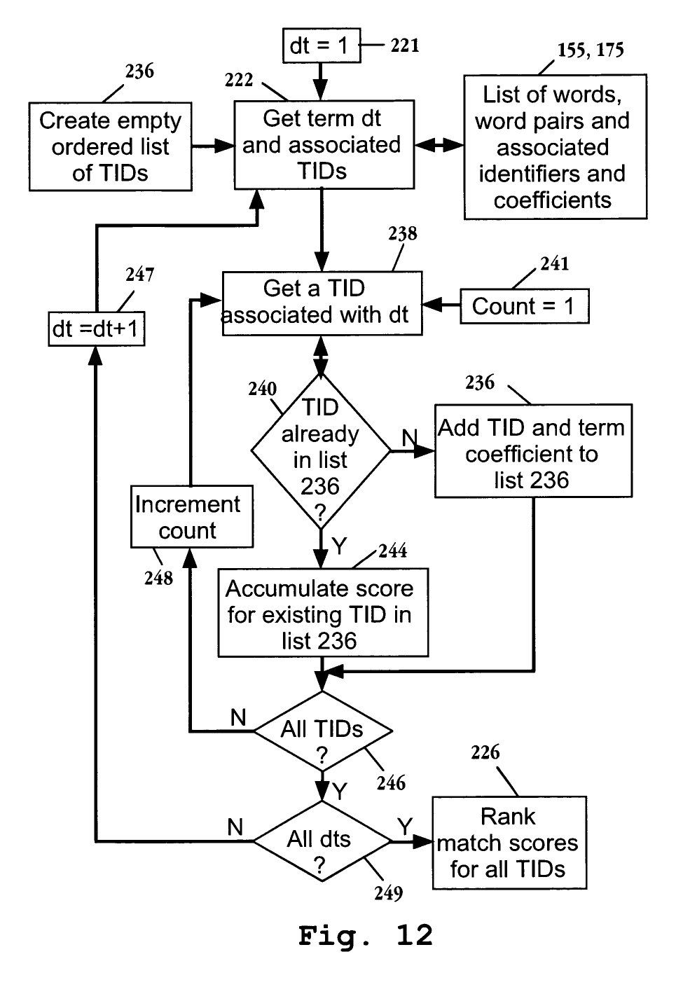

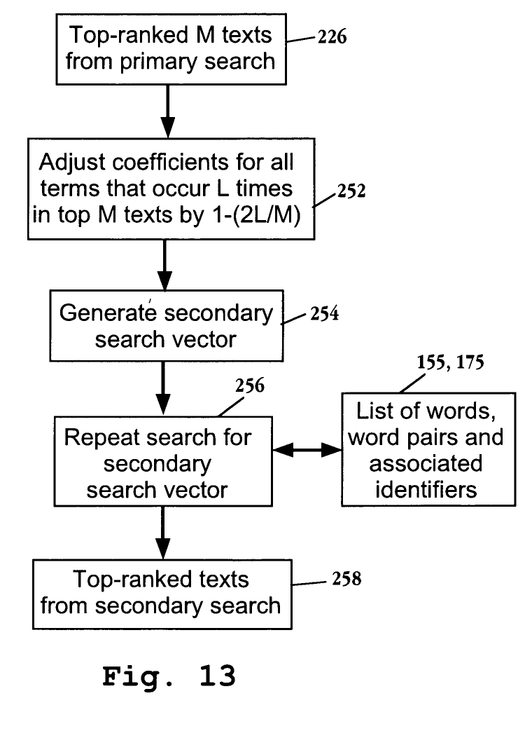

As shown at 74, a database of target-related texts is searched to identify a primary group of texts having highest term match scores with a first subset of the concept-related descriptive terms, and then searched again to identify a secondary group of texts having the highest term match scores with a second subset of the concept-related descriptive terms, where the first and second subsets are at least partially complementary with respect to the terms in the list. In a typical operation, described below with respect to FIGS. 12 and 13, the search vector for the primary search includes all of the descriptive terms, and the primary group of texts includes those texts having highest term overlap with the vector. The vector coefficients are then adjusted to reduce the weight of those terms present in the primary group of texts, yielding the second-search vector. The texts in the secondary group are those with the highest term overlap with the second-search vector.

User input shown at 75 allows the user to adjust the weight of terms in either the primary or secondary search. For example, the user might want to emphasize or de-emphasize a word in either the first or second subset, cancel the word entirely, or move a term from the primary list to the secondary list or vice versa. Following this input, the use can instruct the program to repeat the primary and/or secondary search. The purposes of this user input is to adjust vector term weights to produce search results that are closer in concept or otherwise more pertinent to the target input. As will be seen below, the user may select other search refinements, e.g., to select only those primary references in a given class, or to refine the search vector based on user selection of “more pertinent” and “less pertinent” top ranked texts.

At this stage, the program takes the top ranked primary and secondary references (from an initial or refined search) and forms pairs of the texts, each pair typically containing one primary and one secondary reference, as indicated at 77. Thus, for example, if the program stored the top 20 matches for both primary and secondary searches, the program could form a total of 20×19/2=190 pairs of texts, each pair representing a potential “solution” to the problem posed in the target, that is, a primary, starting point solution, and a modification represented by the secondary reference.

To find the most promising of these many possible solutions, the program is designed to filter the pairs of texts by any one or more of several of criteria that are selected by the user (or may be preselected in a default mode). The criteria include term overlap—the extent to which the terms in one text overlap with those in the second text—or term coverage—the extent to which the terms in both texts overlap with the target vector terms.

Alternatively, user selection at 79 can specify filtering based on the quality of one or both texts in a pair, as judged for example, by the number of times a text has been cited. To this end, the program consults, for each text in a pair, citation record 54 which includes citation scores for all of the TIDs or the top-ranked TIDs in the word-records database.

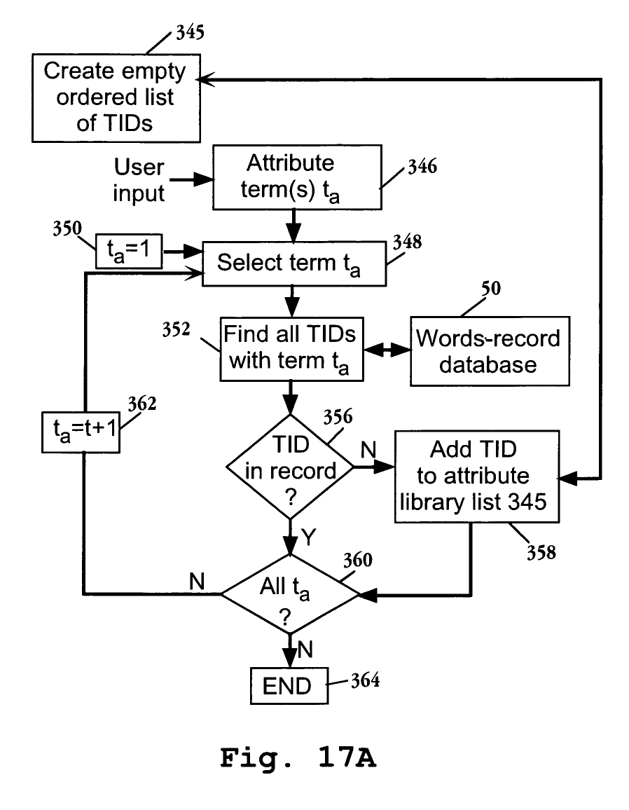

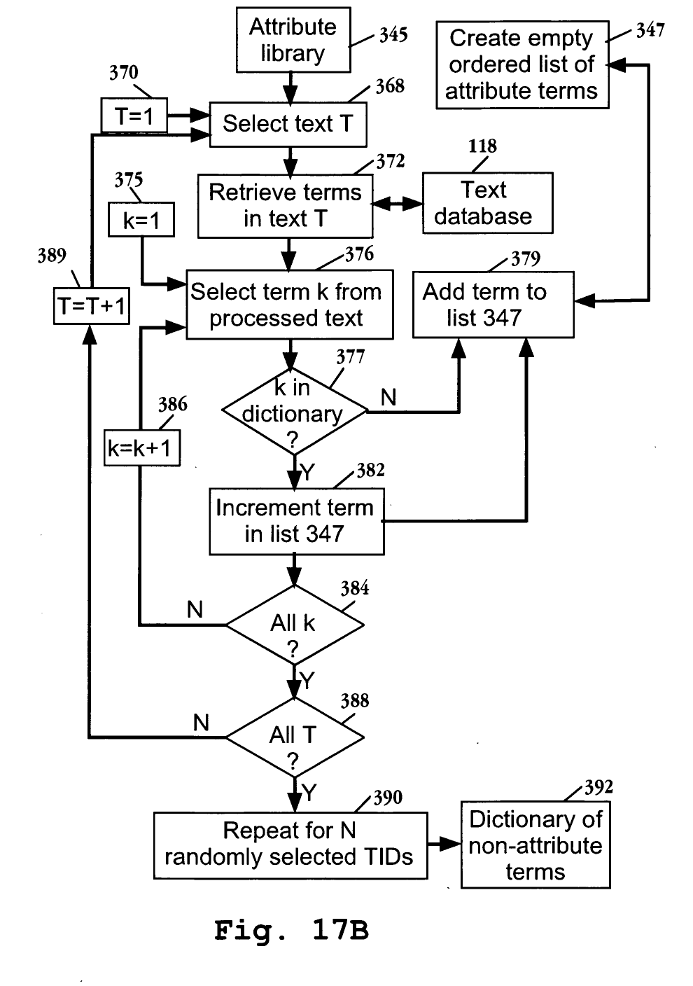

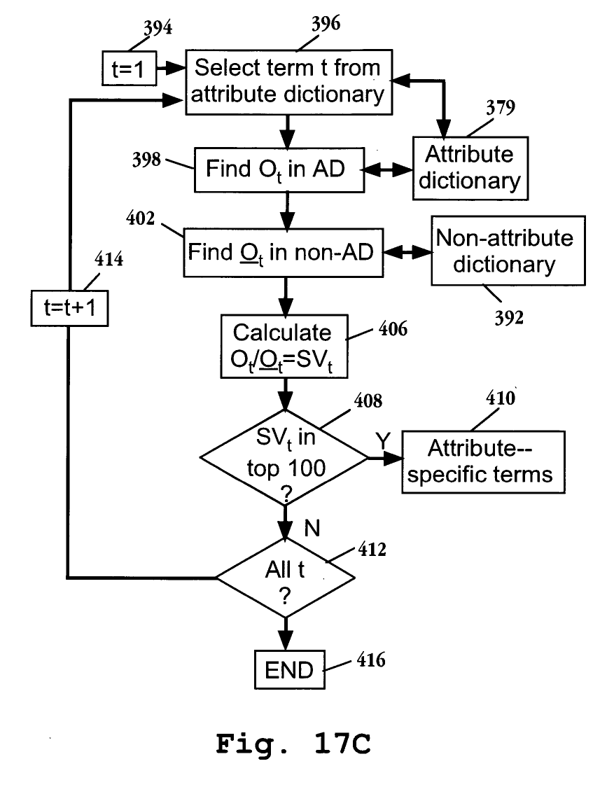

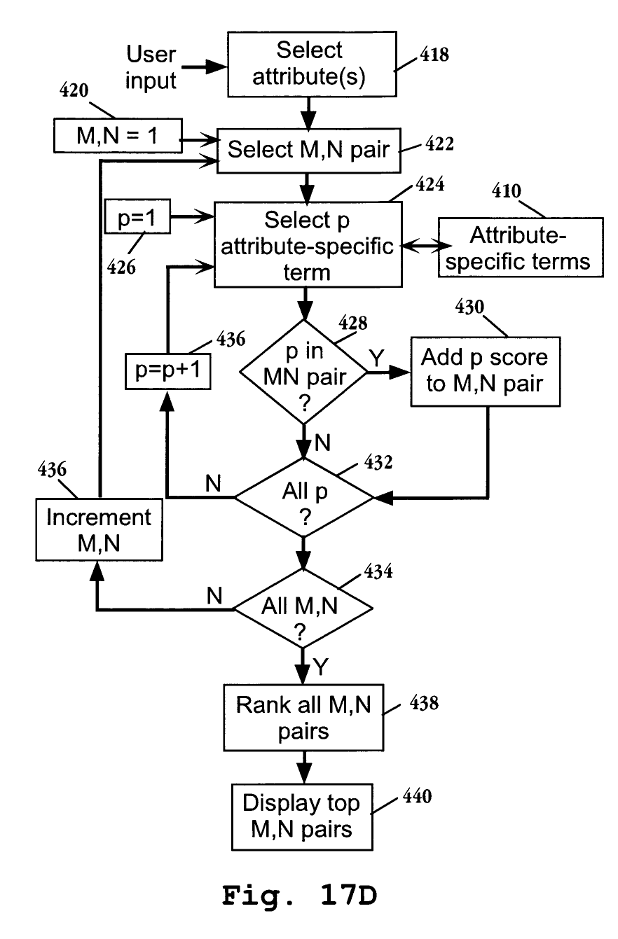

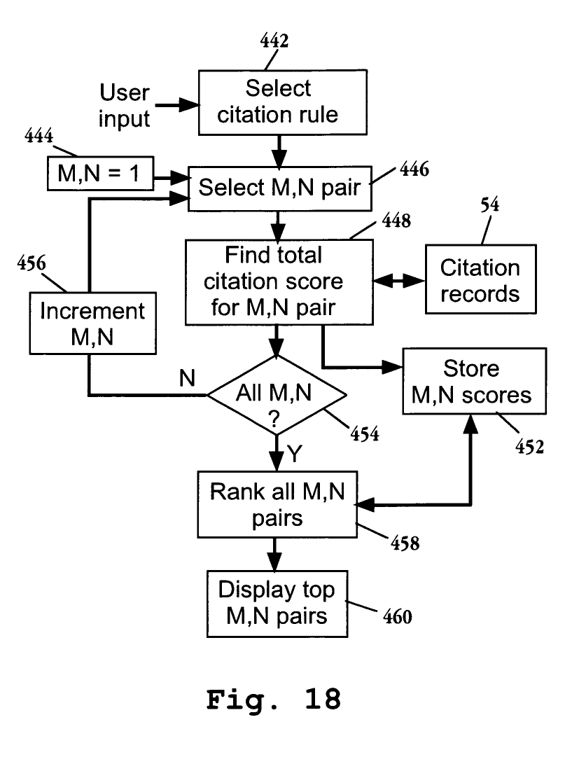

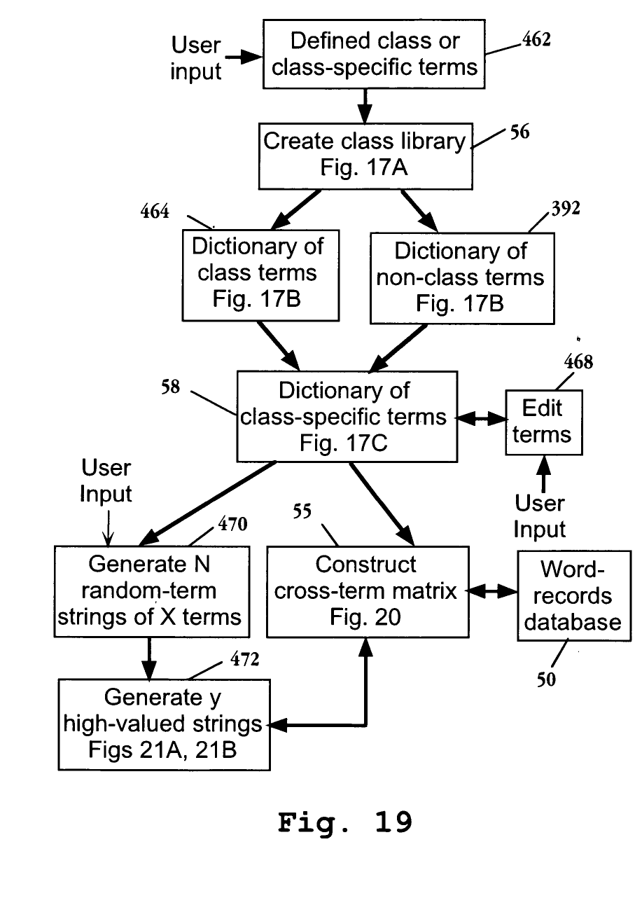

In still another embodiment, user selection at 79 can be used to rank pairs of text on the basis of features or attributes (descriptors) specified by the user. The portion of the program that executes this filter is described in greater detail below with respect to FIGS. 17A-17D. Records of descriptor-specific terms used in this filter are stored at 52. Typically, these records are generated in response to specific descriptors provided by the user in advance, as will be seen. In general, the filter score will be based on (i) for one or more terms in one of the pairs of texts identified as feature terms, the presence in the other pair of texts of one or more feature-specific terms defined as having a substantially higher rate of occurrence in a feature library composed in texts containing that feature term, and (ii) for one or more attributes associated with the target invention, the presence in at least one text in the pair of attribute-specific terms defined as having a substantially higher rate of occurrence in an attribute library composed in texts containing a word- and/or word-group term that is descriptive of that attribute.

Following each filtering operation (or combined filtering operations), the top-ranked pairs of primary and secondary texts are displayed at 78 for user evaluation. As will be described, the user may either accept one or more pairs, as a promising invention or solution, or return the program to its search mode or one of the additional pair filters.

D. Text Processing

There are two related text-processing operations employed in the system. The first is used in processing each text in one of the N defined-class or defined- descriptor libraries into a list of words and, optionally, wordpairs that are contained in or derivable from that text. The second is used to process a target text into meaningful search terms, that is, descriptive words, and optionally, wordpairs. Both text-processing operations use the module whose operation is shown in FIG. 5. The text input is indicated generically as a natural language text 80 in FIG. 5.

The first step in the text processing module of the program is to “read” the text for punctuation and other syntactic clues that can be used to parse the text into smaller units, e.g., single sentences, phrases, and more generally, word strings. These steps are represented by parsing function 82 in the module. The design of and steps for the parsing function will be appreciated form the following description of its operation.

For example, if the text is a multi-sentence paragraph, the parsing function will first look for sentence periods. A sentence period should be followed by at least one space, followed by a word that begins with a capital letter, indicating the beginning of a the next sentence, or should end the text, if the final sentence in the text. Periods used in abbreviations can be distinguished either from an internal database of common abbreviations and/or by a lack of a capital letter in the word following the abbreviation.

Where the text is a patent claim, the preamble of the claim can be separated from the claim elements by a transition word “comprising” or “consisting” or variants thereof. Individual elements or phrases may be distinguished by semi-colons and/or new paragraph markers, and/or element numbers of letters, e.g., 1, 2, 3, or i, ii, iii, or a, b, c.

Where the texts being processed are library texts, and are being processed, for constructing a text database (either as a final database or for constructing a word-record database), the sentences, and non-generic words (discussed below) in each sentence are numbered, so that each non-generic word in a text is uniquely identified by a TID, an LID, and one or more word- position identifiers (WPIDs).

In addition to punctuation clues, the parsing algorithm may also use word clues. For example, by parsing at prepositions other than “of”, or at transition words, useful word strings can be generated. As will be appreciated below, the parsing algorithm need not be too strict, or particularly complicated, since the purpose is simply to parse a long string of words (the original text) into a series of shorter ones that encompass logical word groups.

After the initial parsing, the program carries out word classification functions, indicated at 84, which operate to classify the words in the text into one of three groups: (i) generic words, (ii) verb and verb-root words, and (iii) remaining groups, i.e., words other than those in groups (i) or (ii), the latter group being heavily represented by non-generic nouns and adjectives.

Generic words are identified from a dictionary 86 of generic words, which include articles, prepositions, conjunctions, and pronouns as well as many noun or verb words that are so generic as to have little or no meaning in terms of describing a particular invention, idea, or event. For example, in the patent or engineering field, the words “device,” “method,” “apparatus,” “member,” “system,” “means,” “identify,” “correspond,” or “produce” would be considered generic, since the words could apply to inventions or ideas in virtually any field. In operation, the program tests each word in the text against those in dictionary 86, removing those generic words found in the database.

As will be appreciated below, “generic” words that are not identified as such at this stage can be eliminated at a later stage, on the basis of a low selectivity value. Similarly, text words in the database of descriptive words that have a maximum value at of below some given threshold value, e.g., 1.25 or 1.5, could be added to the dictionary of generic words (and removed from the database of descriptive words).

A verb-root word is similarly identified from a dictionary 88 of verbs and verb-root words. This dictionary contains, for each different verb, the various forms in which that verb may appear, e.g., present tense singular and plural, past tense singular and plural, past participle, infinitive, gerund, adverb, and noun, adjectival or adverbial forms of verb-root words, such as announcement (announce), intention (intend), operation (operate), operable (operate), and the like. With this database, every form of a word having a verb root can be identified and associated with the main root, for example, the infinitive form (present tense singular) of the verb. The verb-root words included in the dictionary are readily assembled from the texts in a library of texts, or from common lists of verbs, building up the list of verb roots with additional texts until substantially all verb-root words have been identified. The size of the verb dictionary for technical abstracts will typically be between 500-1,500 words, depending on the verb frequency that is selected for inclusion in the dictionary. Once assembled, the verb dictionary may be culled to remove words in generic verb words, so that words in a text are classified either as generic or verb-root, but not both.

In addition, the verb dictionary may include synonyms, typically verb-root synonyms, for some or all of the entries in the dictionary. The synonyms may be selected from a standard synonyms dictionary, or may be assembled based on the particular subject matter being classified. For example, in patent/technical areas, verb meanings may be grouped according to function in one or more of the specific technical fields in which the words tend to appear. As an example, the following synonym entries are based a general action and subgrouped according to the object of that action:

Create/Generate

assemble, build, produce, create, gather, collect, make, generate, create, propagate, build, assemble, construct, manufacture, fabricate, design, erect, prefabricate, produce, create, replicate, transcribe, reproduce, clone, reproduce, propagate, yield, produce create, synthesize, make, yield, prepare, translate, form, polymerize,
   Join/Attach
attach, link, join, connect, append, couple, associate, add, sum, concatenate, insert, attach, affix, bond, connect, adjoin, adhere, append, cement, clamp, pin, rivet, sew, solder, weld, tether, thread, unify, fasten, fuse, gather, glue, integrate, interconnect, link, add, hold, secure, insert, unite, link, support, hang, hinge, hold, immobilize, interconnect, interlace, interlock, interpolate, mount, support), derivatize, couple, join, attach, append, bond, connect, concatenate, add, link, tether, anchor, insert, unite, polymerize, couple, join, grip, splice, insert, graft, implant, ligate, polymerize, attach.

As will be seen below, verb synonyms are accessed from a dictionary as part of the text-searching process, to include verb and verb-word synonyms in the text search.

The words remaining after identifying generic and verb-root words are for the most part non-generic noun and adjectives or adjectival words. These words form a third general class of words in a processed text. A dictionary of synonyms may be supplied here as well, or synonyms may be assigned to certain words on as as-needed basis, i.e., during classification operations, and stored in a dictionary for use during text processing. The program creates a list 90 of non- generic words that will accumulate various types of word identifier information in the course of program operation.

The parsing and word classification operations above produce distilled sentences, as at 92, corresponding to text sentences from which generic words have been removed. The distilled sentences may include parsing codes that indicate how the distilled sentences will be further parsed into smaller word strings, based on preposition or other generic-word clues used in the original operation. As an example of the above text parsing and word-classification operations, consider the processing of the following patent-claim text into phrases (separate paragraphs), and the classification of the text words into generic words (normal font), verb-root words (italics) and remainder words (bold type).

A device for monitoring heart rhythms, comprising:
means for storing digitized electrogram segments including signals indicative of depolarizations of a chamber or chamber of a patient's heart;
means for transforming the digitized signals into signal wavelet coefficients;
means for identifying higher amplitude ones of the signal wavelet coefficients; and
means for generating a match metric corresponding to the higher amplitude ones of the signal wavelet coefficients and a corresponding set of template wavelet coefficients derived from signals indicative of a heart depolarization of known type, and
identifying the heart rhythms in response to the match metric.

The parsed phrases may be further parsed at all prepositions other than “of”. When this is done, and generic words are removed, the program generates the following strings of non-generic verb and noun words.
monitoring heart rhythms
storing digitized electrogram segments
signals depolarizations chamber patient's heart
transforming digitized signals
signal wavelet coefficients
amplitude signal wavelet coefficients
match metric
amplitude signal wavelet coefficients
template wavelet coefficients//
signals heart depolarization
heart rhythms
match metric.

The operation for generating words strings of non-generic words is indicated at 94 in FIG. 5, and generally includes the above steps of removing generic words, and parsing the remaining text at natural punctuation or other syntactic cues, and/or at certain transition words, such as prepositions other than “of.”

The word strings may be used to generate word groups, typically pairs of proximately arranged words. This may be done, for example, by constructing every permutation of two words contained in each string. One suitable approach that limits the total number of pairs generated is a moving window algorithm, applied separately to each word string, and indicated at 96 in the figure. The overall rules governing the algorithm, for a moving “three-word” window, are as follows:
1. consider the first word(s) in a string. If the string contains only one word, no pair is generated;
2. if the string contains only two words, a single two-wordpair is formed;
3. If the string contains only three words, form the three permutations of wordpairs, i.e., first and second word, first and third word, and second and third word;
4. if the string contains more than three words, treat the first three words as a three-word string to generate three two-words pairs; then move the window to the right by one word, and treat the three words now in the window (words 2-4 in the string) as the next three-word string, generating two additional wordpairs (the wordpair formed by the second and third words in preceding group will be the same as the first two words in the present group) string;
5. continue to move the window along the string, one word at a time, until the end of the word string is reached.

For example, when this algorithm is applied to the word string: store digitize electrogram segment, it generates the wordpairs: store-digitize, store- electrogram, digitize-electrogram, digitize-segment, electrogram-segment, where the verb-root words are expressed in their singular, present-tense form and all nouns are in the singular.

The word pairs are stored in a list 52 which, like list 50, will accumulate various types of identifier information in the course of system operation, as will be described below.

Where the text-processing module is used to generate a text database of processed texts, as described below with reference to FIG. 6, the module generates, for each text a record that includes non-generic words and, optionally, word groups derived from the text, the text identifier, and associated library and classification identifiers, and WPIDs.

E. Generating Text and Word-Records Databases

The database in the system of the invention contains text and identifier information used for one or more of (i) determining selectivity values of text terms, (ii) identifying texts with highest target-text match scores, and (iii) determining target-text classification. Typically, the database is also used in identifying target-text word groups present in the database texts.

The texts in the database that are used for steps (ii) and (iii), that is, the texts against which the target text is compared, are called “sample texts.” The texts that are used in determining selectivity values of target terms are referred to as “library texts,” since the selectivity values are calculated using texts from two or more different libraries. In the usual case, the sample texts are the same as the library texts. Although less desirable, it is nonetheless possible in practicing the invention to calculate selectivity values from a collection of library texts, and apply these values to corresponding terms present in the sample texts, for purposes of identifying highest-matching texts and classifications. Similarly, IDFs may be calculated from library texts, for use in searching sample texts.

The texts used in constructing the database typically include, at a minimum, a natural-language text that describes or summarizes the subject matter of the text, a text identifier, a library identifier (where the database is used in determining term selectivity values), and, optionally, a classification identifier that identifies a pre-assigned classification of that subject matter. Below are considered some types of libraries of texts suitable for databases in the invention.

For example, the libraries used in the construction of the database employed in one embodiment of the invention are made up of texts from a US patent bibliographic databases containing information about selected-filed US patents, including an abstract patent, issued between 1976 and the present. This patent-abstract database can be viewed as a collection of libraries, each of which contains text from a particular, field. In one exemplary embodiment, the patent database was used to assemble six different-field libraries containing abstracts from the following U.S. patent classes (identified by CID);
I. Chemistry, classes 8, 23, 34, 55, 95, 96, 122, 156, 159, 196, 201, 202, 203, 204, 205, 208, 210, 261, 376, 419, 422, 423, 429, 430, 502, 516;
II Surgery, classes, 128, 351, 378, 433, 600, 601, 602, 604, 606, 623;
III. Non-surgery life science, classes 47, 424, 435, 436, 504, 514, 800, 930;
IV. Electricity classes, 60, 136, 174, 191, 200, 218, 307, 313, 314, 315, 318, 320, 322, 323, 324, 335, 337, 338, 361, 363, 388, 392, 439;
V. Electronics/communication, classes 178, 257, 310, 326, 327, 329, 330, 331, 322, 333, 334, 336, 340, 341, 342, 343, 348, 367, 370, 375, 377, 379, 380, 381, 385, 386, 438, 455, and
VI. Computers/software, classes. 345, 360, 365, 369, 382, 700, 701, 702, 703, 704, 705, 706, 707, 708, 709, 710, 711, 712, 713, 714, 716, 717, 725.

The basic program operations used in generating a text database of processed texts is illustrated in FIG. 6. The program processes some large number L of texts, e.g., 5,000 to 500-000 texts from each of N different-field libraries. In the flow diagram, “T” represents a text number, beginning with the first text in the first library and ending with the Lth processed text in the Nth library. The text number T is initialized at 1 (box 98), the library number I at 1 (box 100), and text T is then retrieved from the collection of library texts 51 (box 102). That text is then processed at 102, as described above, to yield a list of non-generic words and wordpairs. To this list is added the text identifier and associated library and classification identifiers (box 108). This processing is repeated for all texts in library I, through the logic of 110 and 112, to generate a complete text file for library I. All of the texts in each successive library I are then processed similarly, though the logic of 114, 116, to generate N text files in the database.

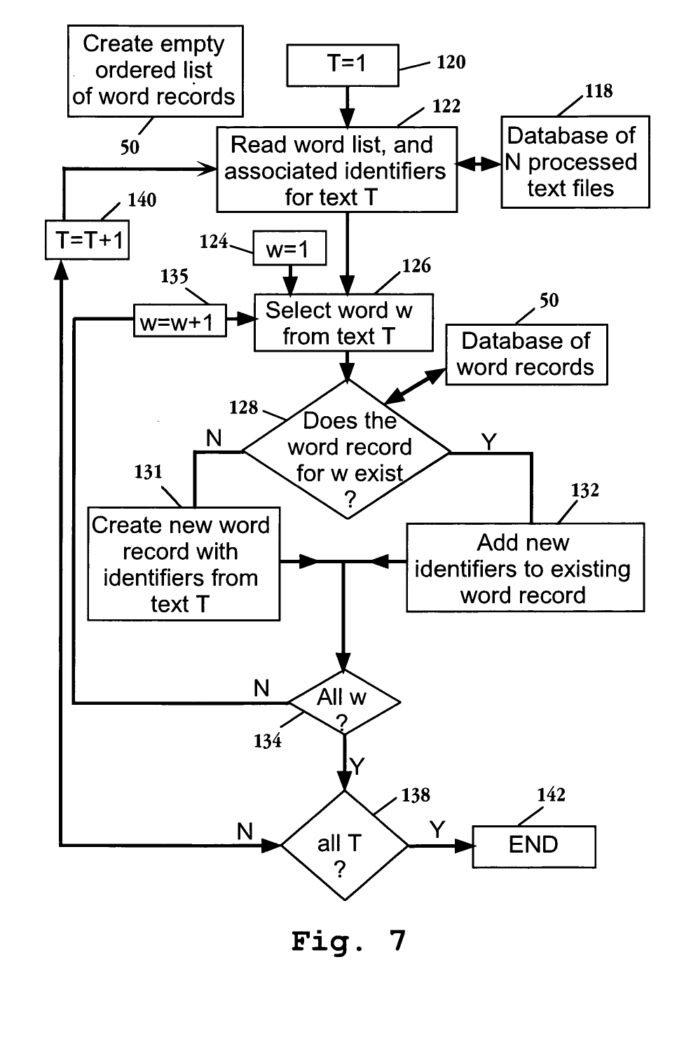

Although not shown here, the program operations for generating a text database may additionally include steps for calculating selectivity values for all words, and optionally wordpairs in the database files, where one or more selectivity values are assigned to each word, and optionally wordpair in the processed database texts. FIG. 7 is a flow diagram of program operations for constructing a word- records database 50 from text database 51. The program initializes text T at 1, (box 120), then reads (box 122) the word list and associated identifiers for text T from database 51. The text word list is initialized word w=1 at 124, and the program selects this word w at 126. During the operation of the program, a database of word records 50 begin to fill with word records, as each new text is processed. This is done, for each selected word w in text T, of accessing the word records database, and asking: is the word already in the database (box 128). If it is, the word record identifiers for word w in text T are added to the existing word record, as at 132. If not, the program creates a new word record with identifiers from text T at 131. This process is repeated until all words in text T have been processed, through to the logic of 134, 135, then repeated for each text, through the logic of 138, 140.

When all texts in all N libraries have been so processed, the database contains a separate word record for each non-generic word found in at least one of the texts, and for each word, a list of TIDs, CIDs, and LIDs identifying the text(s) and associated classes and libraries containing that word, and for each TID, associated WPIDs identifying the word position(s) of that word in a given text.

FIG. 8 shows at pair of word records, identified as “word-x” and “word-y,” in a word record 50 constructed in accordance with the invention. Associated with each word are one or more TIDs, and for each TID, the associated LID, CID, and WPIDs. As shown the word record for word x includes a total of n TIDs. A word record in the database may further include other information, such as selectivity values (SVs) and inverse document frequencies (IDFs), although as will be appreciated below, these values are readily calculated from the TID and LID identifiers in each record

F. Extracting Descriptive Terms

Descriptive terms refers to words and, optionally, word-groups that are descriptive to the subject matter within a given field or class, and are identified on the basis of their selectivity values. The operation of identifying descriptive terms is therefore based on the calculation of selectivity values for those terms, as will be considered in this section. This operation will be employed in identifying descriptive terms contained both in a processed text and in a string of terms.

The present system operates to calculate a separate selectivity value for each of the two or more different text libraries forming a database of texts, where each text library contains texts from a selected field. The selectivity value that is used in constructing a search vector may be the selectivity value representing one of the two or more different libraries of text, that is, libraries representing one or more preselected fields. More typically, however, the selectivity value that is utilized for a given word and wordpair is the highest selectivity value determined for all of the libraries. It will be recalled that the selectivity value of a term indicates its relative importance in texts in one field, with respect to one or more other fields, that is, the term is descriptive in at least one field. By taking the highest selectivity value for any term, the program is in essence selecting a term as “descriptive” of text subject matter if is descriptive in any of the different text libraries (fields) used to generate the selectivity values. In using the system to classify new texts, it may be useful to select the highest calculated selectivity value for a term (or a numerical average of the highest values) in order not to bias the program search results toward any of the several libraries of texts that are being searched. However, once an initial classification has been performed, it may be advantageous to refine the classification procedure using the selectivity values only for that library containing texts with the initial classification.

Selectivity values may be calculated from a text database of word-records database, as described, for example, in U.S. patent application Ser. No. 10/612,739, filed Jul. 1, 2003 and Ser. No. 10/374,877, filed Feb. 25, 2003, all of which are incorporated herein by reference. This section will describe only the operation involving a word-records database, since this approach does not require serial processing of all texts in the database, and thus operates more time efficiently. The operations involved in calculating word selectivity values are somewhat different from those used in calculating wordpair selectivity values, and these will be described separately with respect to FIG. 9 and FIGS. 10A and 10B, respectively. Looking first at FIG. 9, the program is initialized at 156 to the first (text or string) target word w, and this word is retrieved at 158 from the list 155 of target-text words, that is, non-generic words identified from the text-processing operation of a target text or contained in a target string of terms. The program retrieves all TIDs and LIDs (and optionally, CIDs) for this word in database 50. To calculate the selectivity value for each of the N libraries, the program initializes to I=1 at 162, and counts all TIDs whose LID corresponds to I=1 and all TIDs whose LIDs correspond to all other libraries. From these numbers, and knowing the total number of texts in each libraries, the occurrence of word w in libraries I and I, respectively O_{w} and O_{w}, is determined, and the selectivity value calculated as Sᵢ=O_{w}/O_{w} as indicated at 164. This calculation is repeated for each library, through the logic of 166, 168, until all I selectivity values are calculated, and associated with that word in list 155 (box 172). The highest of these values, Sₘₐₓ, is then tested against a threshold value, as at 170. If the Sₘₐₓ is greater than a selected threshold value x, the program marks the word in target list as descriptive, as at 175. This process is repeated for all words in list 155, through the logic of 173, 174, until all of the words have been processed.

The program operations for calculating wordpair selectivity values are shown in FIGS. 10A and 10B. As seen in FIG. 10A, the wordpairs are initialized to 1 (box 176) and the first wordpair is selected at 177 from a file or list 175 of word groups, in this case, word pairs constructed from a processed target text or contained in contained in a target string of terms. The program accesses word- records database 50 to retrieve TIDs containing each word in the wordpair, and for each TID, associated WPIDs and LIDs. The TIDs associated with each word in a word pair are then compared at 179 to identify all TIDs containing both words. For each of these “common-word” texts T, the WPIDs for that text are compared at 181 to determine the word distance between the words in the word pair in that text. Thus, for example, if the two words in a wordpair in text T have WPIDs “2-4” and “2-6” (identifying word positions corresponding to distilled sentence 2, words 4 and 6), the text would be identified as one having that wordpair. Conversely, if no pair of WPIDs in a text T corresponded to adjacent words, the text would be ignored.

If a wordpair is present in a given text (box 182), the TIDs and LID for that word pair are added to the associated wordpair in list 175, as at 184. This process is repeated, through the logic of 186, 188, until all texts T containing both words of a given wordpair are interrogated for the presence of the wordpair. For each wordpair, the process is repeated, through the logic of 190, 192, until all non-generic target-text or target-string wordpairs have been considered. At this point, list 175 contains, for that wordpairs in the list, all TIDs associated with each wordpair, and the associated LIDs.

The program operation to determine the selectivity value of each wordpair is similar to that used in calculating word selectivity values. With reference to FIG. 10B, the wordpair value “wp” is initialized at 1 (box 194), and the first wp, with its recorded TIDs and LIDs, is retrieved from list 175 (box 196). To calculate the selectivity value for each of the N libraries, the program initializes to library I=1 at 198, and counts all TIDs whose LID corresponds to 1=1 and all TlDs whose LIDs correspond to all other libraries. From these numbers, and knowing the total number of texts in each libraries, the occurrence of wordpair wp in libraries I and I, respectively (O_{wp} and O_{wp}) is determined, and the selectivity value S_{I} calculated as O_{wp}/O_{wp} as indicated at 202. This calculation is repeated for each library, through the logic of 203, 204, until selectivity values for all I libraries are calculated. These values are then added to the associated word pair in list 175.

The program now examines the highest selectivity values Sₘₐₓ to determine whether if this value is above a given threshold selectivity value, as at 208. If negative, the program proceeds to the next word, through the logic of 213, 214. If positive, the program marks the word pair as a descriptive word pair, at 216. This process is repeated for each target-text wordpair, through the logic of 213, 214. When all terms have been processed, the program contains a file 175 of each target-text wordpair, and for each wordpair, associated SVs, text identifiers for each text containing that wordpair, and associated CIDs for the texts.

G. Generating a Search Vector

This section considers the operation of the system in generating a vector representation of the target text or target string, in accordance with the invention. As will be seen the vector is used for various text manipulation and comparison operations, in particular, finding primary and secondary texts in a text database that have high term overlap with the target text or string.

The vector is composed of a plurality non-generic words and, optionally, proximately arranged word groups in the document. Each term has an assigned coefficient that includes a function of the selectivity value of that term. Preferably the coefficient assigned to each word in the vector is also related to the inverse document frequency of that word in one or more of the libraries of texts. A preferred coefficient for word terms is a product of a selectivity value function of the word, e.g., a root function, and an inverse document frequency of the word. A preferred coefficient for wordpair terms is a function of the selectivity value of the word pair, preferably corrected for word IDF values, as will be discussed. The word terms may include all non-generic words, or preferably, only words having a selectivity value above a selected threshold, that is, only descriptive words.

The operation of the system in constructing the search vector is illustrated in FIGS. 11A and 11C. Referring to FIG. 11A. the system first calculates at 209 a function of the selectivity value for each term in the list of terms 155, 175. As indicated above, this list contains the selectivity values, or at least the maximum selectivity value for each word in list 155 and each wordpair in list 175. The function that is applied is preferably a root function, typically a root function between 2 (square root) and 3 (cube root). One exemplary root function is 2.5.

Where the vector word terms include an IDF (inverse document frequency) component, this value is calculated conventionally at 211 using an inverse frequency function, such as the one shown in FIG. 11B. This particular function is zero valued for a document frequency (occurrence) of less than 3, decreases linearly between 1 and 0.2 over a document frequency range of 3 to 5,000, then assumes a constant value of 0.2 for document frequencies of greater than 5,000. The document frequency employed in this function is the total number of texts in all different-field libraries containing a particular word or word pair in lists 155, 175, respectively, that is, the total number of TIDs associated with a given word or word group in the lists. The coefficient for each word term is now calculated from the selectivity value function and IDF. As shown at 213, an exemplary word coefficient is the product of the selectivity value function and the IDF for that word.

IDFs are typically not calculated for word pairs, due to the relatively low number of word pair occurrences. However, the word pair coefficients may be adjusted to compensate for the overall effect of IDF values on the word terms. As one exemplary method, the operation at 215 shows the calculation of an adjustment ratio R which is the sum of the word coefficient values, including IDF components, divided by the sum of the word selectivity value functions only. This ratio thus reflects the extent to which the word terms have been reduced by the IDF values. Each of the word pair selectivity value functions are multiplied by this function, producing a similar reduction in the overall weight of the word pair terms, as indicated at 217.

The program now constructs, at 219, a search vector containing n words and m word pairs, having the form: SV=c₁w₁+c₂w₂+cₙwₙ+c₁wp₁+c₂wp₂+ . . . cₘwpₘ, where wᵢ are word terms, wpⱼ are word-pair terms, and cₖ are the calculated coefficients for each term.

Also as indicated at 221 in FIG. 11A, the vector may be modified to include synonyms for one or more “base” words (wᵢ) in the vector. These synonyms may be drawn, for example, from a dictionary of verb and verb-root synonyms such as discussed above. Here the vector coefficients are unchanged, but one or more of the base word terms may contain multiple words. When synonyms or employed in the search vector, the word list 155, which includes all of the TIDS for each descriptive word, may be modified as indicated in FIG. 11A. In implementing this operation, the program considers each of the synonym words added, as at 219, and retrieves from database 50, the TIDs corresponding to each synonym, as at 221, forming a search vector with synonyms, as at 220 in FIG. 11C.

As seen in FIG. 11C, the TIDs for each added synonyms are then added to the TIDs in list 50 for the associated base word, as at 225. Final list 155 thus includes (i) each base word in a target text vector, (ii) coefficients for each base word, and (iii) all of the TIDs containing that word and (iv) if a base word includes synonyms, additionally all TIDs for each synonym.

H. Identifying Primary and Secondary Groups of Matched Texts

The search function in the system, illustrated in FIG. 12, operates to find primary and secondary database texts having the greatest term overlap with the target search vector terms, where the value of each vector term is preferably weighted by the term coefficient.

An empty ordered list of TIDs, shown at 236 in the figure, stores the accumulating match-score values for each TID associated with the vector terms. The program initializes the vector term at 1, in box 221, and retrieves term dt and all of the TIDs associated with that term from list 155 or 175. As noted in the section above, TIDs associated with word terms may include TIDs associated with both base words and their synonyms. With TID count set at 1 (box 241) the program gets one of the retrieved TIDs, and asks, at 240: Is this TID already present in list 236? If it is not, the TID and the term coefficient is added to list 236, as indicated at 236, creating the first coefficient in the summed coefficients for that TID. Although not shown here, the program also orders the TIDs numerically, to facilitate searching for TIDs in the list. If the TID is already present in the list, the term coefficient is added to the summed coefficients for that term, as indicated at 244. This process is repeated, through the logic of 246 and 248, until all of the TIDs for a given term have been considered and added to list 236.

Each term in the search vector is processed in this way, though the logic of 249 and 247, until each of the vector terms has been considered. List 236 now consists of an ordered list of TIDs, each with an accumulated match score representing the sum of coefficients of terms contained in that TID. These TIDs are then ranked at 226, according to a standard ordering algorithm, to yield an output of the top N match score, e.g., the 10 or 20 highest-ranked matched score, identified by TID.

The program then functions to adjust the search vector for identifying a second group of texts that have high term overlap with those terms in the original vector that are unmatched or poorly matched (underrepresented) with terms in the top-score matches from the primary (first-tier) search. This operation is carried out, in one embodiment, according to the steps shown in FIG. 13. As seen in this figure, the program takes the primary-search texts with the top M scores, typically top 10 scores (box 226 from FIG. 13), and adjusts the vector coefficients to reflect the number of times L any term has appeared in the top M primary texts. This can be done, for example, by adjusting each coefficient by the factor 1−(2L/M), as indicated at 252. In this example, if a term appears in 4 (L) of the top 10 (M) primary search texts, the original coefficient for that term would be multiplied by a factor of 1-8/10 or 0.2. Similarly, if a term has appeared not at all or only once in the top M primary texts, its vector value will remain largely unchanged. The program thus generates a new search vector based on the adjusted coefficients (box 254). This secondary-search vector may lack some of the terms of the original vector (where the term has appeared in all M top primary references), and have other terms with significantly reduced coefficients.

This new vector becomes a secondary search vector, more heavily weighting those words or word pairs that were underrepresented or unrepresented in the primary search. The secondary or second-tier search described with respect to FIG. 12 is repeated, at 256, to yield a list of top-ranked texts for the secondary terms. If desired, one or more additional searches aimed at capturing texts that are underrepresented in the primary and secondary searches may be carried out in a similar manner.

More generally, the program operates to identify a primary group of texts having highest term match scores with a first subset of the concept-related descriptive terms, where this first subset includes those descriptive target terms present in the top-matched texts. The database is then searched again to identify a secondary group of texts having the highest term match scores with a second subset of the concept-related descriptive terms, where this second subset includes descriptive target terms that are either not present or under- represented in the top-matched texts. The first and second subsets of terms are at least partially complementary with respect to the terms in the list. That is, the first subset of terms may include terms present in the list that are not present in the second subset of terms. In the text-searching operation described above, the first and second subsets of terms have substantial overlap.

In a typical search operation, the program stores a relatively large number of top-ranked primary and secondary texts, e.g., 1,000 of the top-ranked texts in each group, and presents to the user only a relatively small subset from each group, e.g., the top 20 primary texts and the top ten secondary texts. Those lower-ranked texts that are stored, but not presented may be used in subsequent search refinements operations, as will be described in the section below. In the embodiment described herein, a text is displayed to the user as a patent number and title. By highlighting that patent, the corresponding text, e.g., patent abstract or claim, is displayed in a text-display box, allowing the user to efficiently view the summary or claim from any of the top-ranked primary or secondary references.

I. User Feedback Options for Refining the Search Results

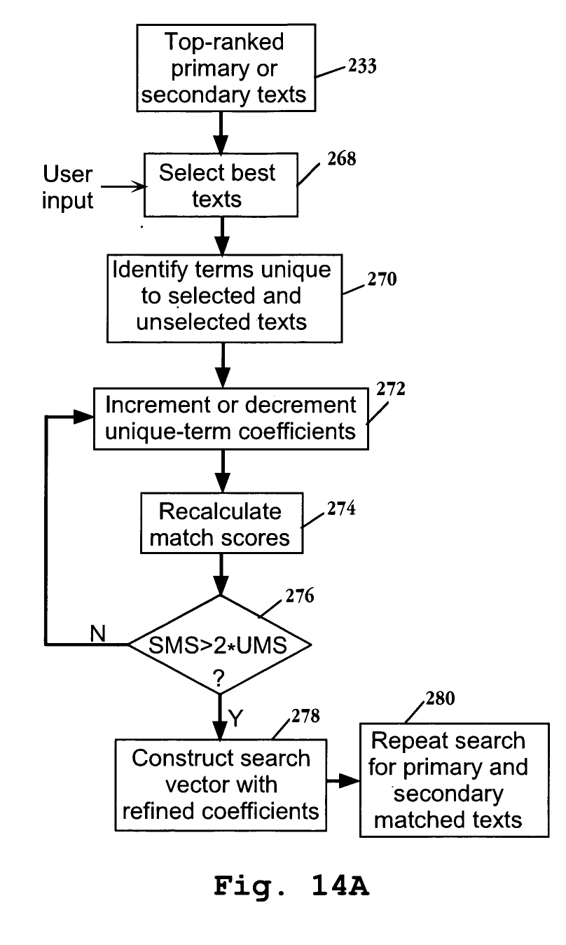

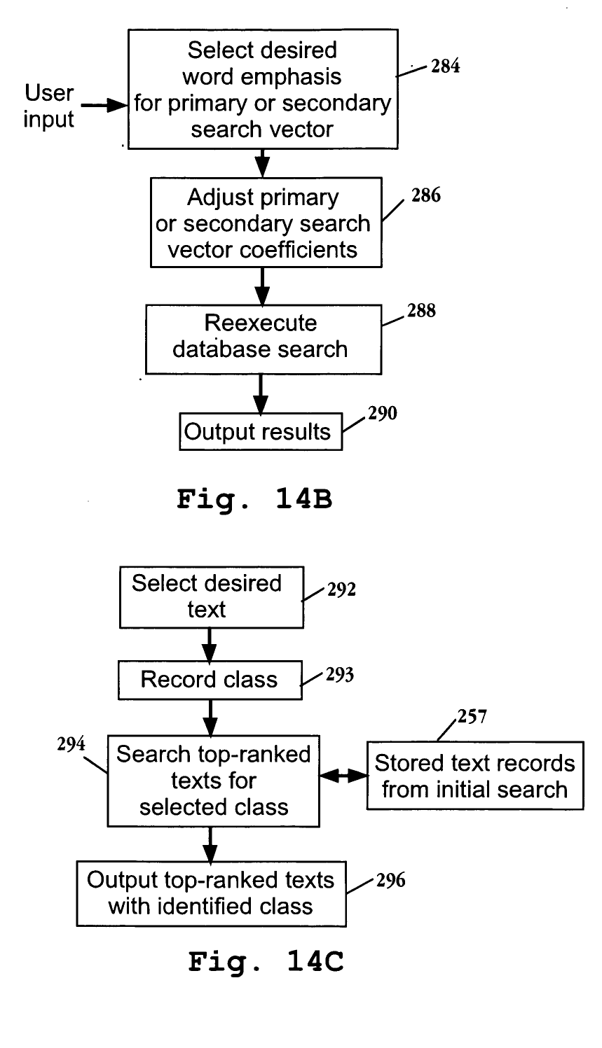

Once the initial search to determine primary and secondary groups of texts with maximum term overlap with the target primary- and second-search vectors is completed, the program allows the user to assess and refine the quality of the search in a variety of ways. For example, in the user-feedback algorithm shown in FIG. 14A, the top-ranked, e.g., top 20 primary references are presented to the user at 233. The user then selects at 268 those text(s) that are most pertinent to the subject matter being searched, that is, the subject matter of the text, or most related to a desired starting point for concept generation. If the user selects none of the top-ranked texts, the program may take no further action. If the user selects all of the texts, the program may present additional lower-ranked texts to the user, to provide a basis for discriminating between pertinent and less-pertinent references.

Assuming one or more, but not all of the presented texts are selected, the program identifies those terms that are unique to the selected texts (STT), and those that are unique to the unselected texts at 270 (UTT). The STT coefficients are incremented and/or the UTT coefficients are decremented by some selected factor, e.g., 10%, and the match scores for the texts are recalculated based on the adjusted coefficients, as indicated at 274. The program now compares the lowest-value recalculated match score among the selected texts (SMS) with the highest-value recalculated match score among the unselected texts (UMS), shown at 276. This process is repeated, as shown, until the SMS is some factor, e.g., twice, the UMS. When this condition is reached, a new search vector with the adjusted score is constructed, as at 278, and the search is text search is repeated, as shown. Rather than search the entire database with the new search vector, the search may be confined to a selected number, e.g., 1,000, of the top matched texts which are stored from the first search, permitting a faster refined search.

Another user-feedback feature allows the user to “adjust” the coefficients of particular terms, e.g., words, in the search vector, and/or to transfer a given term from a primary to a secondary search or vice versa. As will be seen below, the user interface for the search presents to the user, all of the word terms in the search vector, along with a number-pair indicator to show the numbers of texts in the top ten primary texts (first number of the pair) and in the top ten secondary texts (second number in the pair) that contain that word. Wordpair may be similarly reported if desired. For each word, the user can select from a menu that includes (i) “default,” which leaves the term coefficient unchanged, (ii) “emphasize,” which multiplies the term coefficient by 5, (iii) “require,” which modifies the term coefficient by 100, and (iv) “ignore,” which multiples that term coefficient by 0. The user may also elect to “move” a word from “P” to “S” or vice versa, for example, to ensure that a term forms part of the search for the secondary reference. The user feedback to adjust vector coefficients and search category (P or S) is shown at 284 in FIG. 14B.

Based on the user selections, the program adjusts the term coefficients, as above, and places any selected terms specifically in the primary or secondary search vectors. This operation is indicated at 286. The program now re- executes the search, typically searching the entire database anew, to generate a new group of top-ranked primary and secondary texts, at 288, and outputs the results at 290. Alternatively, the user may select a “secondary search” choice, which instructs the program to confine the refined search to the modified secondary search vector. Accordingly, the user can refine the primary search in one way, e.g., by user selection of most pertinent texts, and refine the secondary search in another way, e.g., by modifying the coefficients in the secondary- search vector.

Another refinement capability, illustrated in FIG. 14C, allows the user to confine the displayed primary or secondary searches to a particular patent class. This is done, in accordance with the steps shown in FIG. 14B, by the user selecting a desired text in the group of displayed primary or secondary texts. The program then searches the top-ranked texts stored at 257, e.g., top 1,000 primary texts or top 1,000 secondary texts, and finds, at 294, those top-ranked texts that have been assigned the same classification as the desired (selected) text. The top-ranked texts having this selected class are then presented to the user at 296. This capability may be useful, for example, where the user identifies one text that is particularly pertinent, and wants to find all other related texts that are in the same patent class as the pertinent text.

The search and refinement operations just described can be repeated until the user is satisfied that the displayed sets of primary and secondary references represent promising “starting-point” and “modification” references, respectively, from which the target invention may be reconstructed.

J. Combining and Filtering Pairs of Primary and Secondary Texts

The sections above describe text-manipulation operations aimed at (i) identifying or generating a target concept in the form of a target text or target term string, (ii) converting the text or term string into a search vector, (iii) using the search vector to identify primary and secondary groups of references that represent “starting-point” and “modification” aspects of concept building, and optionally, (iv) refining the search results by user input. This section describes the final text-manipulation operations in which the program combines primary and secondary texts to form pairs of texts representing candidate “solutions” to the target input, and various filtering operations for assessing the quality of the text pairs as candidate solutions, so that only the most promising candidates are displayed to the user.

The step of combining texts is carried simply by forming all permutations of the top-ranked M primary texts and top-ranked N secondary texts, e.g., where M an N are both the top-ranked 20 texts in each of the two groups, yielding M×N pairs of texts. These pairs may then be presented to the user 20, for example in order of total match score of the primary and secondary texts contained in each pair. The user is able to successively view the texts corresponding with each of M, N texts. In viewing these references, the user might identify a good primary (starting-point) text, for example, and then view only those N pairs containing that primary text.

The filtering operations in the system are designed to assist the user in evaluating the quality of pairs as potential “solutions,” by presenting to the user, those pairs that have been identified as most promising based on one, or typically two or more, of the following evaluation criteria:
(i) Term overlap. This filter quantifies the extent to which terms in the primary text overlap with those of the secondary text in any given pair. A high overlap score indicates that the two texts of a pair share a number of descriptive target terms in common, and are thus likely to be concerned with the same field of invention, or involve common elements or operation.
(ii) Term coverage. Alternatively, or in addition, the system may filter texts pairs based on the extent to which the target-descriptive terms in both texts in a pair cover or span all of the target-descriptive terms. The score that is accorded to each pair is preferably weighted by the target-term coefficients, so that the relative importance of terms is preserved. A high coverage score indicates that collectively, the first and second text in a pair are likely to provide most or all of the important elements of the target.
(iii) Attribute score. Often the user will be able to identify certain attributes that target invention should have, such as “energy efficient,” “capable of being fabricated on a microscale,” “amenable to massive parallel synthesis,” “easily detectable,” or “smooth-surfaced.” When this filter is selected, the program first generates a group of terms that are “attribute-specific” for the indicated attribute, meaning terms that are found with some above-average frequency in texts concerned with the indicated attribute. The program then looks for the presence of one or more of these attribute specific terms in one or both texts in a pair. A high attribute score indicates that at least one of the two references in a pair may have some connection with the attribute desired in the target invention.
(iv) Feature score. Features and attributes are both concept “descriptors” that are characterized by “descriptor-specific” terms, that is, terms that occur with above average frequency in texts containing that descriptor (attribute or feature) term(s). A feature, rather than an attribute, is selected if the user wishes to identify pairs of texts in which the feature term itself is present in one of the two texts in a pair, and a feature-specific term in the other text of the pair. A high feature score indicates that the two texts may be linked by a common, specified feature.
(v) Citation score. One measure of the quality of a text, as a potential starting point or modification text, is the text's citation score, referring to the number of times that text has been cited in subsequent texts, e.g., patents. This filter screens pairs of texts based on a total citation score for both texts of a pair, and therefore displays to the users those pairs of texts having highest overlap citation quality.

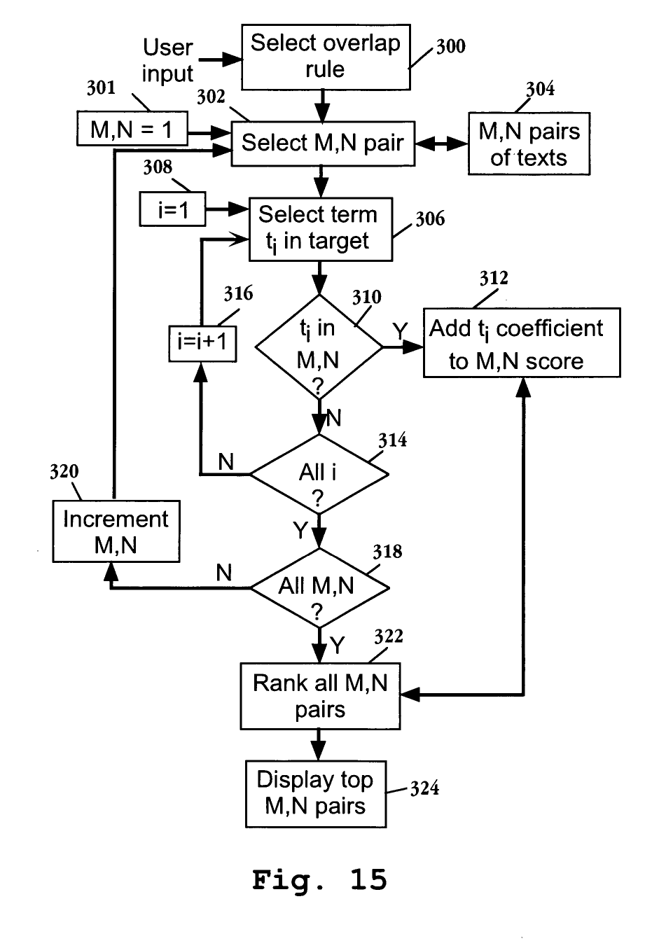

The algorithm for the overlap rule filter is shown in FIG. 15. After the user selects the overlap rule at 300, the system operates to select one of the M×N pairs, e.g., 400 pairs of 20 primary and 20 secondary texts from the file 304 of stored text pairs, initializing the pair, M, N=1, as at 301. The first target term tᵢ is then selected at 306, and both the primary (M) and secondary (N) texts are interrogated to determine whether tᵢ is present in both texts, as shown at 310. If the term is not present in both texts, the program proceeds to the next term, through the logic of 314 and 316. If the term is present in both texts, the vector coefficient for that term is added to the score for pair M,N, at 312, before proceeding to the next term. The process is repeated until all of the terms in pair M,N, e.g., 1, 1, have been considered and scored.

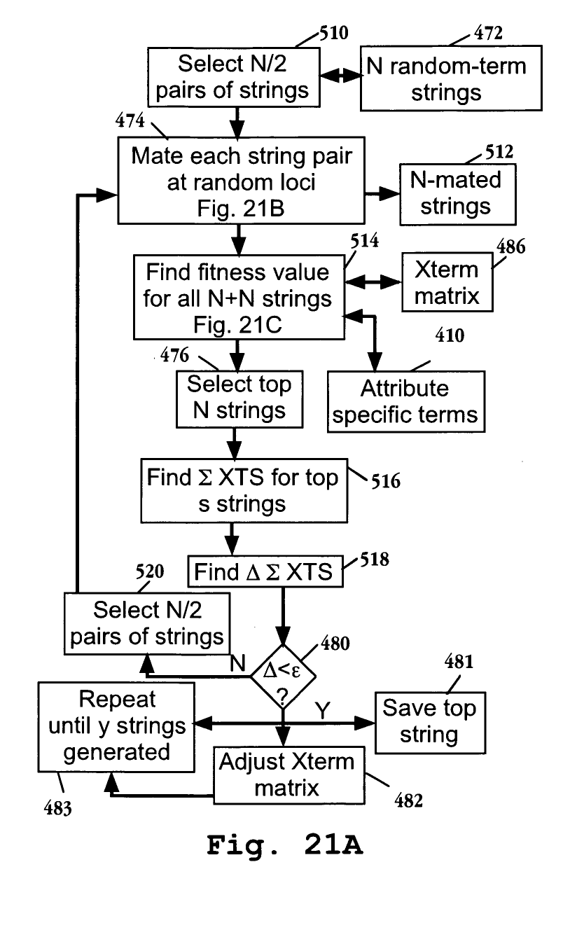

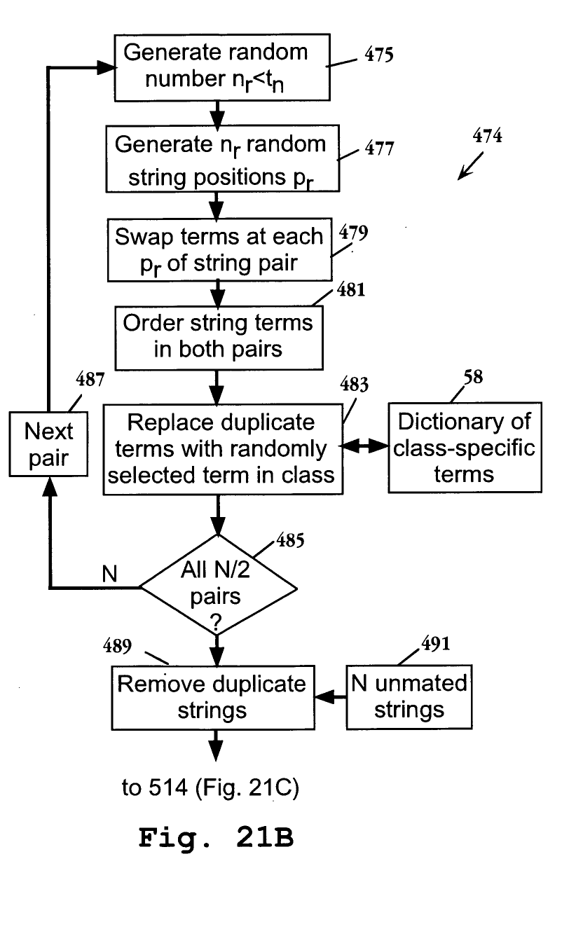

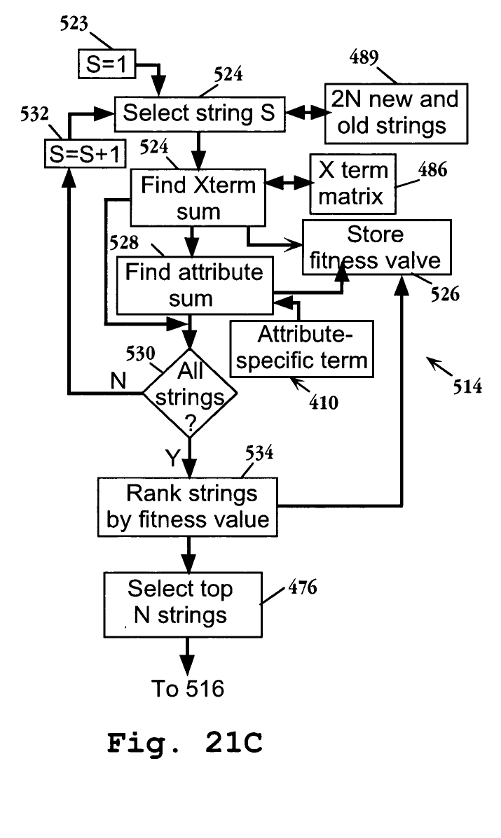

The system then proceeds to the next pair, e.g., 1,2, through the logic of 318, 320, producing a second overlap score at 312, and this process is repeated until all M×N pairs have been processed. The pair scores from 312 are now ranked, at 322, and the top-ranked pairs, e.g., 1-3, 4-6, 1-6, etc., are displayed to the user at 324 for viewing. As seen in the user interface shown in FIG. 21, the user can highlight any indicated pair, e.g., 4-6, and the corresponding primary and secondary texts will be displayed in the associated text boxes.

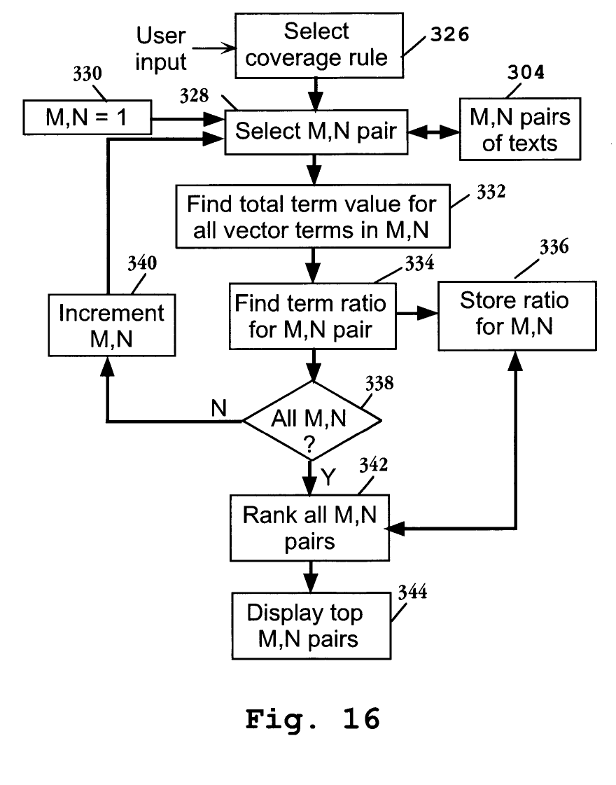

If the user selects the coverage rule, the program will operate according to the algorithm in FIG. 16 to find pairs of text with maximum target-term overlap. User selection is at 326. The program initializes M, N=1, retrieves this first text pair from file 304, and determines the sum of target-term coefficients for all target terms in either M or N, at 332. The coverage value is expressed as a ratio of the calculated M, N, pair value to the total value of all target-term coefficients, as indicated at 334. This ratio is stored in a file 336. The system then proceeds to the next pair, through the logic of 338, 340, until all of the M×N pairs have been considered. The pair scores from 336 are now ranked, at 342, and the top- ranked pairs are displayed to the user at 344 for viewing. As noted above, the user can highlight any indicated pair, and the corresponding primary and secondary texts will be displayed in the associated text boxes in the output interface.

The operation of the system in filtering text pairs based on one or more specified attributes is illustrated in FIGS. 17A-17D, where the flow diagram in FIG. 17A illustrates steps in the construction of an attribute library. When the user selects an “attribute” filter, the program creates an empty ordered list file of TIDs at 345 and the interface displays an input box 346 in FIG. 17A at which one or more terms, e.g., word and word pairs, that describe or characterize a desired attribute are entered by the user. For example, if the attribute selected is “easily detected,” the user might enter the attribute synonyms of “easily or readily” in combination with “detect or measure, or assay, or view or visualize.” Each of these input terms is an attribute term tₐ.

With tₐ initialized to 1 (box 350), the program selects the first term (box 348), and finds all TIDS with that term from words-records database 50, as described above for word terms (FIG. 9) and word-pair terms (FIGS. 10A and 10B), as indicated at 352. For each TID identified with a particular term, the program asks whether that TID is already present in the file 345, at 356. If no, that TID is added to file 345, at 358. This process is repeated for all TIDs associated with the selected tₐ, then repeated successively for each tₐ, through the logic of 360, 362, until all of the attributes have been so processed. At the end of this operation (box 364), file 345 contains a list of all TIDs that contain one or more of the attribute terms. This file thus forms an “attribute library” of all texts containing one or more of the attribute terms.

Although not shown here, the program also generates a “non-attribute” library of texts, that is, a library of texts that do not contain attribute terms, or contain them only with a low, random probability. The non-attribute library may be generated, for example, by randomly selecting texts from the entire database, without regard to content or terms. Typically, the size of (number of texts in) the non-attribute library is large enough, e.g., 5,000-10,000 texts, to provide a good statistical measure of the occurrence rate of a term in a “non-attribute” library.

The attribute file is then used, in the algorithm shown in FIG. 17B, to construct a dictionary of attribute terms, that is, terms that are associated with texts in the attribute library. As shown in the figure, the program creates an empty ordered list of attribute terms at 347, initializes the attribute-library texts T to 1, then selects a text T from the attribute library. The terms in text T are extracted from processed text T from a text database 51 whose construction is described with reference to FIG. 6. Each term, i.e., word and wordpair, extracted from text T represents a non-generic term in the text, and is indicated as term k in the figure. With k initialized to 1 (box 375), the program selects a term k from processed text T, at 376 and asks, at 377: is term k in the dictionary of attribute terms, that is, in the dictionary of attribute terms 347. If it is not, it is added to the list at 379. If it is, a counter for that term in the list is incremented by one, at 382 to count the number of texts in the attribute library that contain that term. This process is repeated for all terms k in text T, through the logic of 384, 386. It is then repeated, through the logic of 388, 389, for all texts T in the attribute library. At the end of the operation, the terms in list 347 may be alphabetized, creating a dictionary of attribute terms, where each term in the dictionary has associated with it, the number of texts in the attribute library in which that term appears. As indicated at the bottom of FIG. 17B, a similar process is repeated for the texts in the non-attribute library, as at 390, generating a library 392 of “non- attribute” terms and the corresponding text occurrence of each term among the texts of the non-attribute library. Dictionary 392 will, of course, contain all or most of the terms in the attribute dictionary, but at a frequency that is not specific for any particular attribute, or is specific for a different attribute than at issue.

The flow diagram shown in FIG. 17C operates to identify those terms in the attribute dictionary that are specific for the given attribute. That is, attribute- specific terms are those terms, e.g., words and word pairs that are found with some above-average frequency in texts concerned with that attribute. Functionally, the program operates to calculate the text occurrence of each attribute term in the attribute dictionary, relative to the text occurrence of the same term in the non-attribute library, then select those terms that have the highest text-occurrence ratio, or specificity for that attribute. Typically, some defined number of top-ranked terms, e.g., top 100 words and top 100 word groups, are selected as the final attribute-specific terms.

With reference to FIG. 17C, the program initializes the dictionary terms t to 1 (box 394), and selects the first term t in the attribute dictionary, at 396. To determine the occurrence ratio, the program finds the text occurrence of this term Oₜ in the attribute dictionary (AD) at 398, and the occurrence of the same term Oₜ from the non-attribute dictionary, at 402, and calculates the occurrence ratio Oₜ/ Oₜ at 406, normalized for the ratio of total number of texts in the two libraries. The normalized ratio Oₜ/Oₜ is referred to as the attribute selectivity value (SVₜ). The word and wordpairs having the highest attribute-specific selectivity values, e.g., the top-ranked 100 word and top 100 word-pair terms are placed in a file 410, and each new term thereafter is placed in this file only if its selectivity value is greater than one of the associated words or words pairs already in the file, in which case the lowest-valued word or word pair is removed from the file, through the logic of 408, as the program cycles through each term t, through the logic of 412, 414. The process is complete (box 416) when all terms have been considered, generating a list 410 of top-ranked attribute-specific words and word groups. The file of attribute specific terms also contains the SVₜ associated with each term. As above, the selectivity values of the attribute specific terms may be determined as a function, e.g., log function of selectivity values based on actual text-number occurrences.

In order to allow the user to edit the list of attribute specific terms, the terms may be presented to the user either alphabetically, or ranked according to term selectivity value, according to a user-selected display feature. The user may then highlight and delete any undesired word and/or word-pair terms in the list, creating a shortened list of attribute-specific terms that are then stored in an attribute dictionary.

The application of the attribute filter to pairs of combined texts is shown in FIG. 17D. The user selects one or more attributes at 418. This may entail selecting a preexisting attribute with its existing file of attribute specific terms, or specifying a new attribute by one or more attribute-related terms, as above. The program initializes the combined texts at M,N=1, at 420, and selects the combined pair M,N, at 422. With p attribute-specific terms initialized to 1, the program selects a term p at 424 from the file 410, and asks at 428: is p in the M, N, pair, that is, is term p contained in either text. If not, the program proceeds to the next term p through the logic of 432 and 436. If the term is in one or both of M,N texts, the program adds the SVₜ score for p to a file 430 before proceeding to the next term. When all terms p have been considered, file 430 contain the total SVₜ score for all terms p in text pair M, N.

The operation is repeated for each M, N text pair, through the logic of 434, 436, until all M,N, pairs of texts have been considered. The attribute-specificity score for all M, N, pairs stored in file 430 are now ranked at 438, and the top pairs are displayed to the user at 440.

The operation of the program for filtering combined texts on the basis of one or more selected features, although not shown here, is carried out in a similar fashion. Briefly, for any desired feature, the user will input one or more terms that represent or define that feature. The program will then construct a feature library and from this, construct a file of feature-specific terms, based on the occurrence rate of feature-related terms in the feature library relative to the occurrence of the same terms in a non-feature library. To score paired texts, based on a selected feature, the program looks for pairs of texts that contain the feature itself in one text, and a feature-specific term in the other text, or pairs of texts which each contain a feature-specific term.

FIG. 18 illustrates the operation of the system in filtering pairs of texts on the basis of “quality” of texts, as judged by the number of times that text, e.g., patent has been cited in later-published texts, normalized for time, i.e., the period of time the text has been available for citation. To activate this filter, the user selects the citation rule or filter at 442. The program initializes the paired texts M, N to 1, and finds the total citation score for the two references. This is done at 448 by looking up the citation score for each text in the pair, from a file of citation records 45, and adding the two scores. The citation records are prepared by systematically recording each TID in a text database, scoring the number of times that TID appears as a cited reference in later-issued texts, and dividing the citation score by the age, in months, or the text, to normalize for citation period. The citation score for that text M, N is stored at 452, and the process is repeated, through the logic of 454 and 456, until all M,N pairs have been assigned a citation score. These scores are then ranked at 458, and the top M,N pairs, e.g., top 10 pairs are displayed to the user.

It will be appreciated that two or more of the filters may be employed in succession to filter pairs of texts on different levels. For example, one might rank pairs of texts based on term overlap, then further rank the pairs of texts with a selected attribute filter, and finally on the basis of citation score. Where two or more filters are employed, the program may rank pairs of text based on an accumulated score from each filter, or alternatively, successively discard low- scoring pairs of texts with each filter, so that the subsequent filter operation only considers the best pairs from a previous filter operation.

K. Generating Multi-Term Strings Representing a Concept

This section considers the operation of the system in generating strings of terms (word and/or word-pair terms) that represent a candidate solution for a novel concept in a selected field. FIG. 19 provides an overview of the string- generating operation, which begins with the selection by the user of a novel concept class defined by one or more concept-specific terms, or by the number or name of a recognized class, e.g., a patent-office classification. This user selection is indicated at 462.

Given this input, the program constructs a class library (box 56), analogous to the steps described above with respect to FIG. 17A for the construction of an attribute library. That is, the library is constructed to include all texts contained within the specified class, or all texts containing one or more of the specified class-related terms. This library is then used to construct a dictionary of class-related word and word-pair terms (box 464), following the steps described above with respect to FIG. 17B for constructing a dictionary of attribute-specific terms. Using a dictionary 392 of terms from randomly selected texts, also described above with respect to FIG. 17B, the program then calculates a class-specific selectivity value for each term in dictionary 464, and selects the top ranked of these, e.g., the top-ranked 100 words and top-ranked 100 wordpairs, to produce a dictionary 58 of class-specific terms.

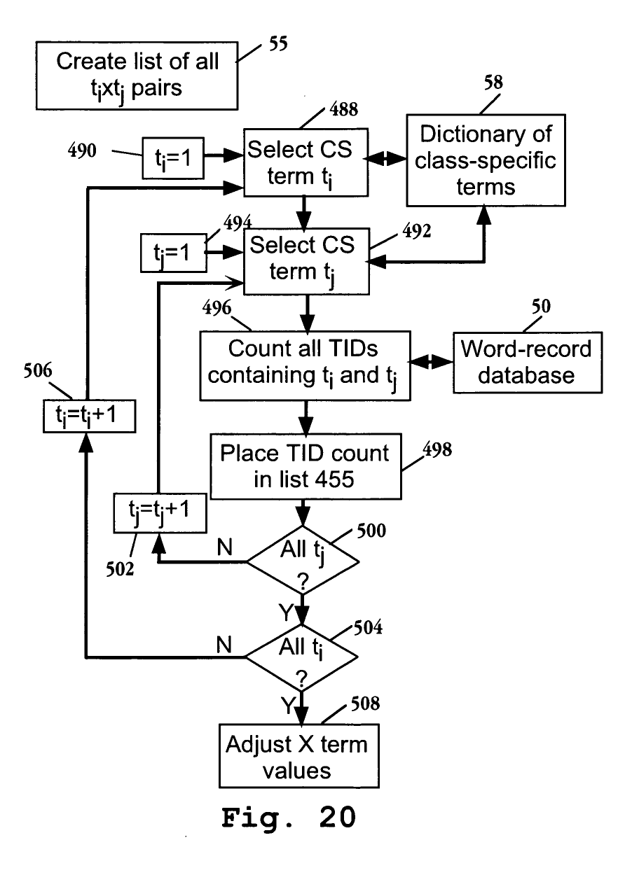

Once the dictionary of class-specific terms is generated, it is used to generate a cross-term matrix 55 whose cross-term values represent the occurrence rate of each pair of terms in a selected library of texts, as will be considered below with respect to FIG. 20. That is, the matrix provides a quantitative measure of the extent to which any two terms in the class-specific dictionary appear together in the same texts in a selected library. This library may include, for example, patent abstracts from several technical fields, or from a selected technical field or from one or more selected classes, e.g., the same class from which dictionary 58 is generated. In the present embodiment, the program constructs the cross-term matrix from patent-abstract texts contained in several technical fields.

The first step in generating concept-related strings is to use terms from dictionary 58 to generate a large number, e.g., 10³-10⁷, of random-term strings having some user-specific length tₙ, typically between 8-30 terms (box 470). One strategy is to generate a large group of, for example, 10⁷ strings, calculate a fitness value for each of these strings (see FIG. 21B), and select the highest scoring, e.g., top 10³ strings for further evolutionary selection. Alternatively, a smaller group, e.g., 10³ strings, can used directly for evolutionary selection. In limited studies conducted to date, the final strings generated appear to be similar in both cases; that is, with or without a pre-screening step. With these N strings as a staring point, the program employs a genetic algorithm to produce high- fitness strings through many generations of string matting and fitness selection. The operation of the program for mating and selecting high-valued strings, starting the initially generated N strings, is indicated at 472 in the figure, and described below with reference to FIGS. 21A-21C.

The construction of a class-related cross-term matrix 55 will be considered with reference to FIG. 20. For each new class matrix, the program creates a list of all tᵢxtⱼ pairs of terms, where (i) tᵢ and tⱼ are word or wordpair terms, (ii) tᵢxtⱼ is equivalent to tⱼxtᵢ, and (iii) diagonal tᵢxtᵢ terms are assigned a value of zero. Thus, for a group of 100 words and 100 wordpairs, this matrix will contain 200×199/2 terms or 19, 900 cross term values.

After creating an empty list of tᵢxtᵢ pairs (box 55), the program initializes tᵢ at 1 (box 490), selects a first term tᵢ from dictionary 58 (box 488), initializes tⱼ to 1 (box 494) and selects a first term tⱼ from the same dictionary from among the N dictionary terms (box 492). The program then counts the number of TIDs containing both tᵢ and tⱼ, as at 496. In the case of a word term, the TIDs for each term are retrieved from word-records database 50 (these could be all TIDs for a given word, or only those TIDs for a selected field or a selected class) and then compares the two TID lists to identify those TIDs containing both word terms. The identified TIDs are counted to yield a raw cross-term value, which is placed in list 55 as at 498.

In the case of a wordpair term, TIDs containing a given wordpair are identified as described above with respect to FIGS. 10A and 10B, and stored in a temporary file (not shown). This TID list is then compared with a word or another wordpair TID list, to identify those TIDs containing both terms, and again the total TIDs are counted to yield a raw cross-term value. The process is repeated for all tⱼ, through the logic of 500, 502, and then for all tᵢ, through the logic of 504, 506.

Once all of the raw cross-term values have been determined and placed in list 55, final cross-term values are determined as a function of the raw value, typically a logarithmic function, and the resulting values may be further normalized to fall within some specified range of values, e.g., 0-5, so that the range of values in any class matrix is the same. These operations are considered at 508.

Similar to what has been described with respect to generation of attribute terms, the user may edit field-specific terms at 468 to remove superfluous or other unwanted terms, where the terms may be presented to the user, for example, alphabetically or according to selectivity value, according to a user- selected display. If any terms are deleted, a new cross-term matrix is generated by removing from the original matrix, all “row” and “columns” containing a deleted term, and redimensionalizing the matrix to reflect the smaller number of rows and columns. The adjusted cross-term matrix is stored along with the field name and field-specific terms in a suitable field file.

The operation of the system in generating high-fitness strings of terms representing candidate concepts in a selected field are considered in FIGS. 21A- 21C. It will be recalled that the program initially generated N, e.g., 1,000 strings of length tₙ each (box 472). For mating, the N strings are divided into two groups of N/2 strings each, at 510, and one string from each group is paired with another from the second group for mating. String mating may be carried out by crossing over portions of each paired string, according to a conventional chromosomal crossing over operation (see, for example, Mitchell, M, “An Introduction to Genetic Algorithms,” MIT Press, 1996, which is incorporated herein by reference. Alternatively, mating may be carried out by exchanging individual randomly selected terms from each of the paired strings, as indicated at 474, and described below with reference to FIG. 21B. In yet a third approach, “mating” is carried out by “mutating” each of the N strings by randomly exchanging some of the terms in the string with other class-specific terms from dictionary 58. Each of the three methods yields N new strings at 512. These are added to the preexisting N strings, and a fitness value is determined for each of the 2N strings at 514.

A preferred mating operation for a pair of strings is shown in FIG. 21B. The program initially generates a random number nᵣ which is less than tₙ, the total number of terms in any string (box 475), then generates nᵣ random string positions pᵣ at which a term exchange will occur (box 477). At each position Pr, the terms of the two paired strings are now exchanged (box 479), generating two new strings. The terms in the new strings are ordered at 481 according to a term-index number, e.g., 1 to 200, assigned to each term in the dictionary of class-specific terms. This ordering will facilitate certain operations below that involve term and string comparisons.

The first of these comparison operations is to examine each of the two new strings for duplicate terms. This is done simply by scanning each of the ordered-term strings for two of the same terms appearing together in the string. If a term duplication is found in a string, the program replaces one of the two duplicate terms with a new term randomly selected from dictionary 58, as shown at 483.

This mating operation is repeated for all N/2 pairs of strings, through the logic of 485, 487, until all N/2 pairs have been mated. A second string-term comparison operation is now carried out (box 489) to remove all duplicate strings, that is, strings having the same tₙ terms. This operation is applied to both the N newly generated “offspring” strings and the N preexisting “parent” strings. Briefly, the program identifies all strings having a common first term, all strings having a common second term, and so on, forming tₙ groups having a common term at one position at least. These tₙ groups are then used to identify all strings that have a common first term and a common second term, then to find all groups that have a common first term, a common second term, and a common third term, and so on, all n terms have been considered. Any pair of strings among the 2N tested that has a common term at all tₙ positions is identified as a duplicate, and one of the duplicates is eliminated.

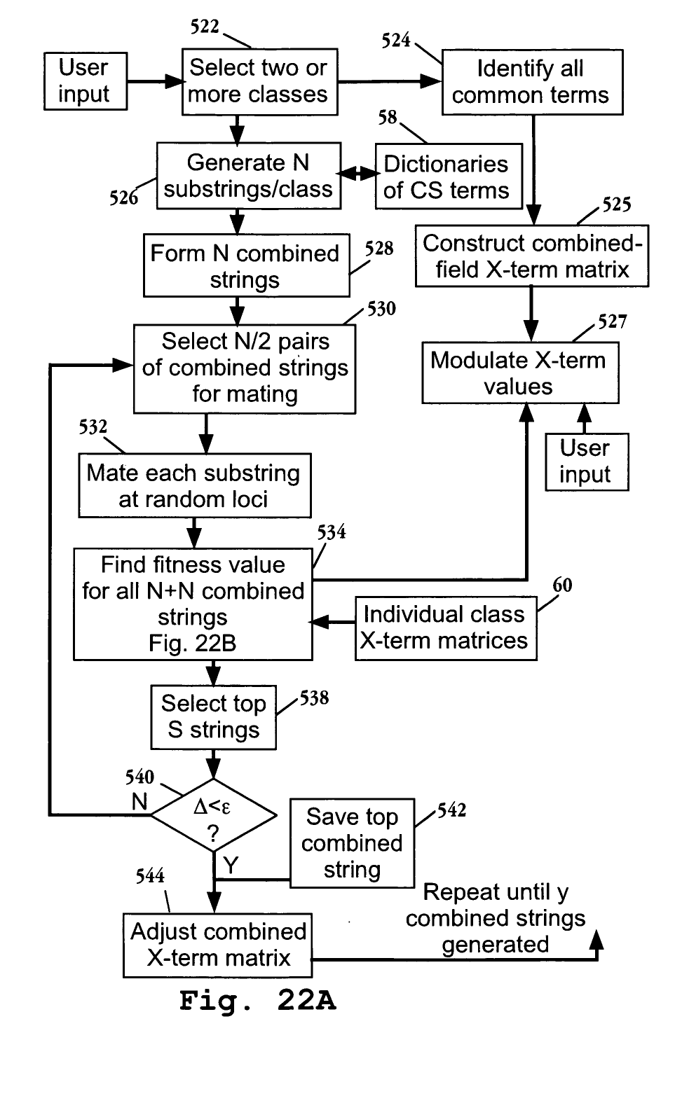

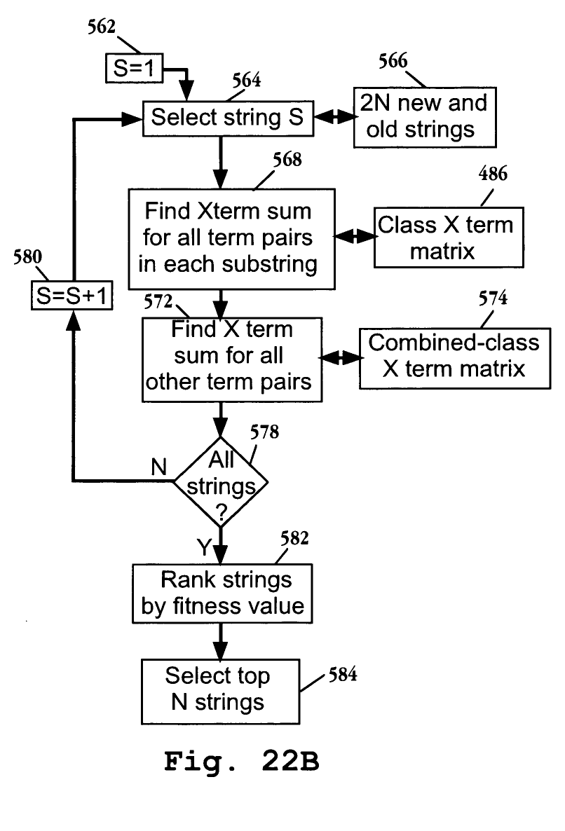

The 2N parent and offspring strings (minus any duplicates) are now scored for string fitness, using a fitness metric related to one or both of the following: (a) for pairs of terms in the string, the number occurrence of such pairs of terms in texts in a selected library of texts; and (b) for terms in the string, and for one or more preselected attributes, attribute-specific selectivity values of such terms. A preferred metric is the number occurrence of pairs of terms in a string, determined from the associated class cross-term matrix. As will be described with respect to FIG. 21C, this metric is computed as the sum of all cross-term matrix values for all term pairs in the string. Alternatively or in addition, the string fitness score may be determined by the application of an attribute metric, as indicated at 410 in FIG. 21C. Here, a string is examined for the presence of attribute-specific terms, as in FIG. 17D, for one or more specified attributes, to bias the strings in favor of terms associated with one or more desired attributes, as shown in FIG. 22C.

With continued reference to FIG. 21C, S, representing a string number, is initialized to 1 (box 523), and string S is selected from the 2N parent and offspring strings at 489. The fitness metric applied here is the sum of cross-term values, as a measure of the extent to which the pairs of terms in the string tend to be localized in other texts, e.g., texts representing other inventions. The cross-term sum is determined (box 524) by forming all n(n−1)/2 tₙ×tₙ₋₁ pairs of terms in a string, finding the cross-term matrix value for each pair from matrix 486, and summing all of these values.

Although not shown in the figures, the string scoring method may also be designed to maintain a certain percentage of word-group terms, since in some cases, word-group terms will have lower text-occurrence rates, and therefore lower cross-term matrix values, and therefore may tend to be displaced from the strings based strictly on cross-term value scoring. One simple approach to the problem is to discard all strings that have less than a given percentage of terms, e.g., less than 1 word-pair term/2 word terms, and alternativiely, or in addition, to replace all duplicates terms during string mating operations with a randomly selected word pair term.

After scoring the 2N strings for fitness, the top N strings are selected at 476, and a total fitness score for the top s strings, e.g., top 10 strings is calculated at 516 in FIG. 21A to serve as marker for the overall quality of the evolving strings. As indicated at 516, this calculation may involve the total cross- term score for all of the top s strings. During successive iterations of the program, this value is compared with the value from the succeeding mating, at 518, to determine a change in value from one iteration to the next. As long as this delta value is above a selected threshold ε₁ the program repeats the above string-mating and selection steps, through the logic of 520. Typically, 500-1,000 iterations or more will be required for convergence. Once convergence has occurred, the top-ranked string or strings are saved, at 481, and new strings may be generated.

With continued reference to FIG. 21A, the string with the highest fitness value from the end is saved at 481. If additional high-fitness strings are desired, the program may either repeat the above process, without any change in cross- term matrix values, until a given number y, e.g., 5-10 strings are generated. In general, the y strings will tend to differ, if at all, at most by a few terms, with the divergence between strings becoming greater, typically, with longer string lengths, e.g., string lengths between 20-50 terms. Alternatively, and as indicated ay 482, the program may make some adjustment to the cross-term matrix values, to force the next iteration toward a different highest-fitness string. One such approach is to adjust the class cross-term matrix values by setting all the cross-terms in the highest fitness string just-generated to zero, so that these particular term pairs will not contribute to the fitness score in subsequently generated strings. This process may be repeated until some desired number y of strings is generated.

The user may also enhance the likelihood that one or more selected class-specific terms will appear in a high-fitness string. This is done, in accordance with another embodiment of the invention, by allowing the user to highlight one ore more selected terms specific to a class. Each cross-matrix term containing one of the highlighted terms is then multipled by a given value, e.g., 2.5-5, to enhance the fitness value that will be attributed to that term when each string-fitness value is being evaluated.

L. Coevolving Strings

As a general strategy for generating new concepts, it is useful to combine elements from two or more selected classes of concepts. For example, if one wanted to apply microfabrication techniques to diagnostic devices, a logical starting point would be to ask such questions as (i) how can microfabrication techniques be used in making or operating diagnostic device, (ii) what types of diagnostic devices could be miniaturized advantageously, or (iii) how can microfabrication techniques be adapted to heat-sensitive or pH-sensitive assay diagnostic components? Regardless of how the problem of generating cross- class concepts is approached, the goal is to combine elements from two or more selected field in same advantageous way to generate a new concept. In one embodiment of the invention, this is done by “coevolving” two or more “substrings” of class-specific terms, employing a modified form of the string- mating and selection method discussed in section K above.

The operation of the system in coevolving substrings from two of more classes will be described below with respect to FIGS. 22A and 22B. As seen in the first of these figures, the user initially selects at 522 two or more classes to combine. It is assumed that the selected classes have already been previously selected and class-specific term dictionaries and cross-term matrices have already been generated. If not, the program will execute the steps described above to generate the associated dictionaries and matrices.

After selection of the two or fields, the program finds and compares terms in the two or more selected fields and outputs the percent term overlap at 524, to indicate to the user the extent to which the selected fields have common terms. For, example, if each of two selected fields contains 100 word terms and 100 word-pair terms, the program will compare each of the 200 terms in one field with each of the 200 terms in the second field. This is done by selecting a first term from the first field term dictionary 58, and comparing the selected term with all other terms in the second field, taken from the second-field dictionary 58. If a term match is found, it is recorded, and the program then advances to the next term in the first field, until all ti,tj matching terms are found. If two fields have few or no matching terms, there may be little value in producing coevolved strings, since each string will have substantially independent of the other.

Once the matching terms are found, the program will construct a combined cross-term (combined X-term) matrix at 525. This matrix will consist of all pairs of terms that are present in both fields, and basically consists of one of the selected-field cross-term matrices, where all cross terms in which both pair of terms are common to both field retain the selected-field cross-term value of the matrix and all other cross-term values are set to zero. If more than two different fields are selected, the combined cross-term matrix consists of all pairs of terms that are common to any two of the fields.

In order to adjust the relative weight accorded to cross-terms that cross the two substrings (one term of the pair is present in one substring and the other, in the second, or another, substring), the program provides a user input at 527 for modulating the cross-term values of the combined-field cross-term matrix. For example, the modulation scale may range from 0.5 to 10, representing the factor by which each term in the combined cross-term matrix 525 is multiplied.

The program operation shown at box 526 involves generating N random- term substrings per class, where each substring preferably has a user-selected number of terms. This is done as described in the section above. The N substrings from each class are then randomly assembled into N strings, each formed of one of the N substrings from each of the selected classes, e.g., two substrings/string when two classes are selected (box 528).

For mating and selecting operations, the N strings are divided into N/2 groups at 530, and each substring is “mated” by random-position term swapping within each substring with the other string pair, essentially as described above, for example, with respect to FIG. 21B, where now term exchange is confined to the two paired substrings within the same class, thus preserving the class- specific terms for each of the selected class. As noted above with respect to FIG. 21B, the term swapping operation may involve selecting random swapping positions in a substrings, and making substring swaps at each swapping position, where the different substrings may be assigned the same swap positions or different ones. These operations are indicated at 532 in FIG. 22A.

Once all N/2 pairs of strings have been mated, the program finds the fitness value for all N newly generated strings, and all N preexisting or parent strings, according to the steps shown in FIG. 22B. Here the program initializes the string number to 1 (box 562) and selects the first strings (box 564) from the collection of 2N parent and offspring strings just described. To score the selected strings, the program applies cross-term matrix and/or an attribute score to separately score each substrings of the selected string, essentially in accordance with the method described above with respect to FIG. 21C. As illustrated in FIG. 22B, this preferably includes generating each term-pair within a substring, consulting the cross-term matrix for the class represented by the substrings, indicated at 486, and summing the cross-term matrix values for each term pair in the substring.

For effective coevolution of the two substrings, the terms in one substring must influence the selection of terms in the other substring. This is done in one embodiment of the present invention, by including in the overall fitness score of a string, a component related to terms pairs in the two or more substrings, that is, one term from each of two substrings. In the embodiment illustrated in FIG. 22B, and shown at box 572, this is done by finding terms pairs for all terms that are common to two classes making up a string, and using the combined cross-term matrix 574 to score all of these pairs, as the sum of the combined cross-term matrix values. As noted above, these matrix values may be user adjusted to produce greater or lesser coupling between the two (or more) substrings forming a string. This cross-substring score is then added to the individual substring scores to produce a final string score.

As an alternative method for assessing the coupling between two substrings in a string, the program can evaluate the extent to which one substring contains class-specific words from the other subclass in a string (or other classes, if a string is composed of more than two substrings). In this method, the program selects a first term from one substring and compares this term with all class-specific terms in the class from which the other substring was generated. If a match is found, the program score the match, either as a unit score or a score related to the class-specific selectivity value of that term. This procedure is repeated until all terms in the substring derived from one class have been compared against all terms in the other class, and the individual matches are summed to produce a cross-correlation score. As with the cross-term matrix values, the overall weight given to the substring coupling may be varied to produce a desired coupling effect. This process is repeated, through the logic of 578, 580, until all 2N strings have been scored. The program removes duplicate strings, as above, ranks the strings by fitness value, as at 582, and selects the top N strings for the next round of string mating.

Also as described above, and with reference again to FIG. 540, the program calculates a combined or total fitness score for the top s, e.g., 10 strings, to provide a measure of string-convergence, and the entire procedure is repeated until this total fitness score Δ is less than a preselected small value ε, as indicated at 540. When this level of convergence is achieved, the program saves the top-ranked string or strings. This process may be repeated until some desired number of co-evolved strings are generated. As above, the different highest-ranking strings are typically quite similar.

Alternatively, and as indicated at 544, the program allows the user to adjust either the combined cross-term matrix coupling values or class-specific cross-term matrix terms and repeat the above process one or more times to generate one or more additional high-fitness strings. As described above, the former modification is done by selecting a different cross-class coupling value, and the latter modification is carried by highlighting specific terms in one or more of the classes forming the string, to enhance the probability that the selected term(s) will appear in the final high-fitness string.

M. Generating Multi-Term Strings Representing a Modified Concept

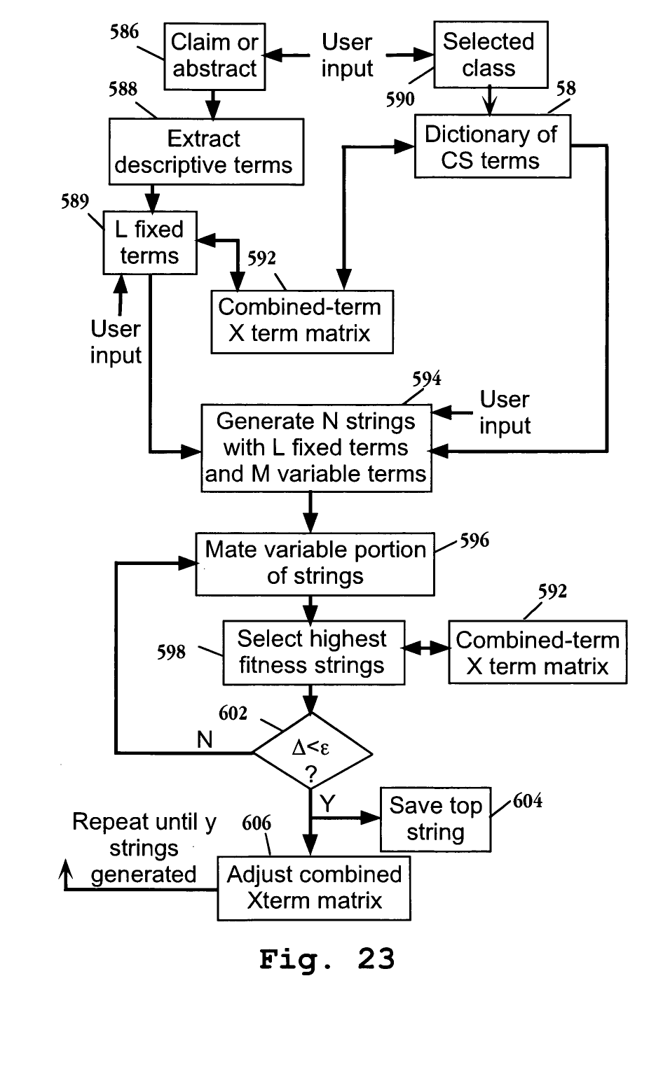

Another type of invention strategy is to build on an existing concept, for example to expand the range of improvements of a new invention or to design around an existing claim. In order to expand a concept, it is also useful to indicate a direction in which one wishes to extend or modify the concept, for example, by indicating a general concept class one wishes to embrace in seeking an improvement or modification. The operation of the system for carrying out this type of concept generating is illustrated in FIG. 23.

Box 586 in the figure represents a claim or abstract of an existing concept, e.g., invention, which is selected by a user and input into the system, e.g., as a natural-language text. The program processes the natural language text, as described above with reference to FIG. 5, and extracts the descriptive words and wordpairs (box 588), essentially as described above with reference to FIGS. 9 and 10A and 10B, respectively. These terms are displayed to the user, and from this list, the user selects, e.g., by highlighting terms, those terms, typically 10-30 terms, that are desired. This is indicated at box 589, showing the user selection of L terms that will be referred to below as “fixed terms.” Alternatively, the user could directly enter L fixed terms representing key terms in the concept to be expanded.

The user also selects, at 590, a concept class that will represent the invention space into which the claim or abstract is to be expanded. When this class is selected or specified, the program generates or accesses a list 58 of class-specific terms, as described above with reference to FIGS. 17A-17C for generating a dictionary of attribute specific terms. Briefly, whether the user input is an recognized class, e.g., PTO class, or defined by one or more class-related terms, the program identifies texts in that class, extracts non-generic terms from those texts, and identifies and selects those terms having the highest class- selectivity values.

The descriptive terms from 588 and the class-specific terms in dictionary 58 are now combined and a combined-term cross-term matrix is generated or accessed (box 592), substantially as described above with respect to FIG. 20. Briefly, for all pairs of the combined terms, the term-pair occurrence frequency, i.e., co-occurrence of both terms of a pair in texts from a selected text library, is determined, and assigned a value related to this ratio, e.g., a value related to the logarithm of the actual occurrence value, to form the matrix 592.

The strings that are generated in this embodiment are made up of a constant portion composed of the selected L fixed terms representing the input concept to be expanded and M variable terms, representing terms from the selected class into which the concept expansion is to occur, as indicated at 594. Typically, the user selects a total string length, composed of L+M terms, of between 10-40 terms. Thus, if the user selects 10 fixed terms at 589, and selects a 15-term string length at 594, the program will generate N strings with the 10 fixed terms and 5 variable terms randomly selected from dictionary 58.

The string mating and selection algorithm, shown at 596, is carried out essentially as described with respect to FIGS. 21A-21C, except that when two strings are mated, only terms in the variable M terms are swapped, the L fixed terms being held constant. The highest fitness strings are determined at 598 essentially as described with reference to FIG. 21C, using the combined term matrix 592 to evaluate fitness of each of the 2N strings, including N parent strings and N offspring strings. This process is repeated through several generations, e.g., 500-1,000, through the logic of 602, until the difference (Δ) between a total fitness score for the top s strings in succeeding generations, is less than a selected value E, indicating convergence of the string fitness values, as described above with reference to FIG. 21A. When convergence is reached, the string(s) with the highest-fitness score(s) are saved, at 604, and the process may be repeated, at 606, for example by adjusting values in the combined-term cross-term matrix, until some desired number of strings are generated.

As in the two sections above, the strings generated may be used directly by the user, as candidate concept, or may be “translated” into natural-language text(s), by using the strings as input terms in the search and text-filtering modules described above.

N. Other Applications for Concept Generation

Although the system described above has been illustrated with respect to generating candidate concepts in technology, e.g., new inventions, it will be appreciated how the algorithms and logic of the system can be readily applied for generating other types of candidate concepts, such as new literary concepts or storylines, or new musical concepts. This section will briefly describe the operation of the system to candidates for novel literary concepts.

To generate novel candidate literary concepts, one first assembles a large number of known storylines, e.g., natural-language summaries of written works of fiction, and/or movies, where each text has a text ID may additionally have a class or library ID, such as all classes or genres related to historical novels, war stories, mysteries, and so on. These texts are processed, as described with reference to FIGS. 5 and 6 above, to produce a database of processed literary texts, and further processed, as described with respect to FIG. 7, to produce a word-records database of all non-generic words from the texts, along with their text and library identifiers.

One or more concepts of interest can be specified by user-input words or word-groups, e.g., Greek tragedies, these input terms are in turn used to generate a concept library, e.g., summaries of all Greek tragedies, and from this, a dictionary of concept specific terms, such as the 100 words and 100 word pairs that have the highest concept-specific selectivity values. The latter are, determined, for example, by comparing word and word-pair occurrence in the concept library against a library of texts that are randomly selected without regard to literary class or genre, or even against a library of texts from a non- fiction field, such as texts relating to social sciences in general. Once a dictionary of concept-specific terms is generated, a cross-term matrix representing the occurrence frequency of pairs of terms in texts in the concept library is created, as detailed above with reference to FIG. 20. A similar approach is used to generate selected attribute and attribute libraries, substantially as described with reference to FIGS. 17A-17C.

Strings of concept-specific terms generated randomly from a dictionary of concept-specific terms are mated and selected for highest-fitness value, substantially as described with reference to FIGS. 21A-21C. Highest-fitness strings may then be “read” directly as a term strings, or translated by using the strings to search the database of texts, employing the various search and filter algorithms described with respect to FIGS. 9-18.

O. User Interfaces

This section describes six user interfaces that are employed in the system of the invention, and is intended to provide the reader with a better understanding of the type of user inputs and machine outputs in the system.

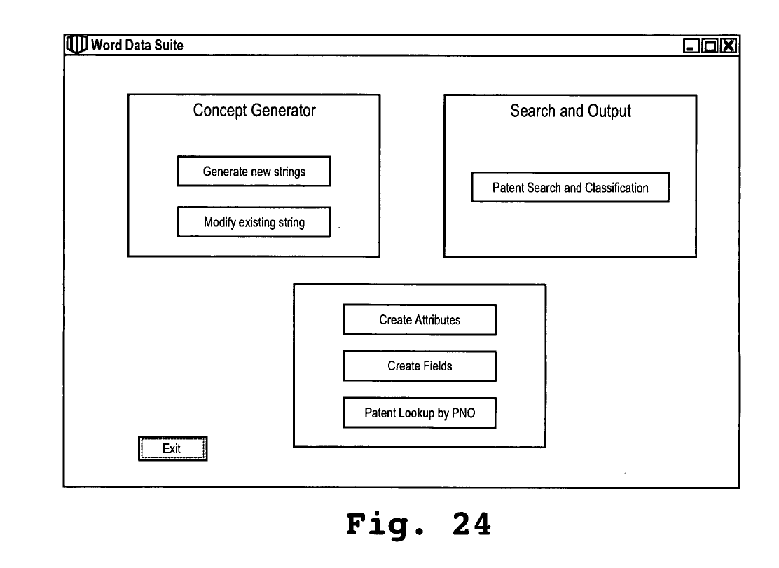

FIG. 24 shows the graphical interface for the system directory. The directory is divided into three groups: “Concept Generator,” which includes separate interfaces for the operations Generate new strings, described in Sections K and L, and Modify existing strings, described in Section M′ Search and Output, which includes the Patent Search and Classification module, described in Sections H and I, and a Patent Text filtering module, described in Section J; and a third group which includes a Patent Lookup by patent number (PNO), and interfaces for generating attribute or class (field) dictionaries, as described above, in Sections J and K, respectively. The patent lookup interface (not shown) allows a user to enter a seven-digit US patent number and retrieve the corresponding patent abstract. This abstract may be copied and transferred to other modules, for example, the module for modifying an existing string (terms extracted from the pasted-in abstract) or the patent search module. In the discussion below, the term “field” that appears in a user interface will denote a field or class as that term is generally used in the sections above.

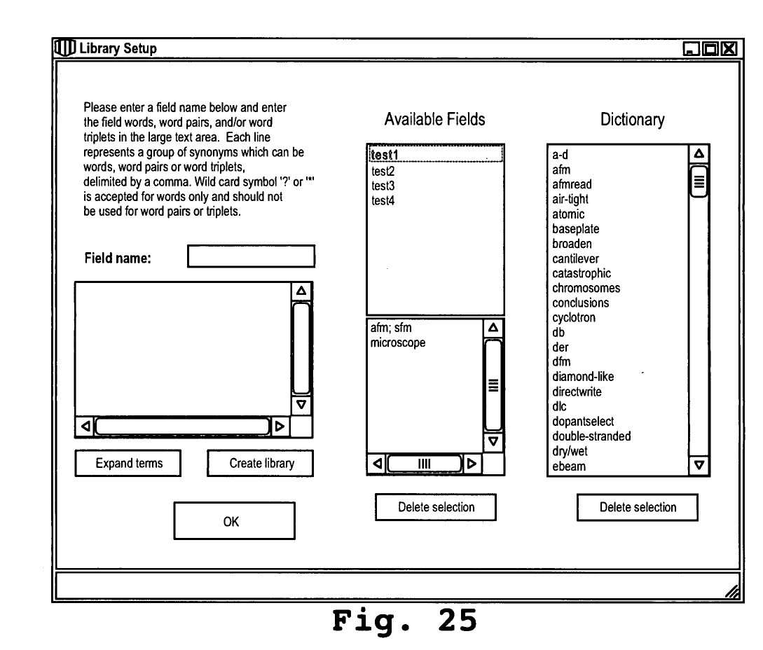

FIG. 25 is the graphical interface for constructing new field (class) libraries or dictionaries, that is, lists of class-specific words for a given concept class. The user enters the dictionary name in the Field name box, and enters one or more synonyms defining that class in the large box below the Field name box. The program may be designed to allow a Boolean representation of the class, such as one in which all synonyms (words or word groups) entered on a single line, each separated by a comma, are treated as an OR command (each comma serves as an OR instruction) that selects all texts that contains at least one of the input synonyms, and terms entered on different lines are treated as AND queries (the paragraph key serves as an AND command), such that the program identifies documents that contain at least one term from each line of input terms. The Expand terms button is activated if the user wants to see expansion of any words that have been truncated with a wildcard symbol, in this case a “?” symbol. The Create library button initiates program operation to (i) identify all texts containing the class-defining terms (the class library), (ii) identify the highest-ranked class-specific terms from the class library, and (iii) generate the cross-term matrix for the top- ranked terms in that class, all as described in Section K above.

The Available Fields box shows the names of different class libraries already created and stored (upper box). Highlighting one of these libraries will bring up the terms used in defining the class (lower box) and a dictionary of class-specific terms for that class (or field). As seen, the program allows the user to edit class-specific terms by highlighting all of those to be deleted, and activating the Delete selection button. Similarly, a class-specific library can be deleted by highlighting that class and activating the Delete selection button. Although not apparent to the user, the program also stores a cross-term matrix for the term pairs in each dictionary.

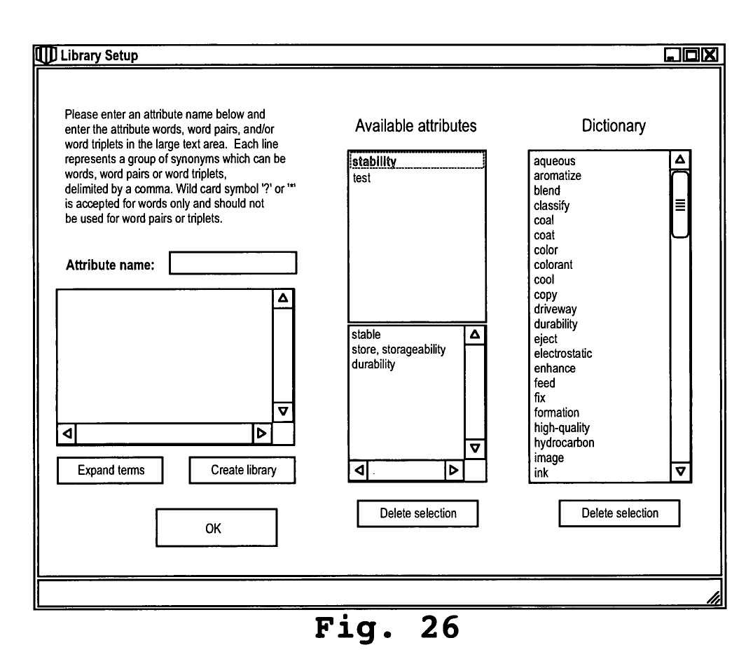

The user interface for generating Attribute dictionaries, shown in FIG. 26, is similar to the interface of FIG. 25, where two boxes at the right allow user identification of an attribute name (small upper box) and a Boolean term command used to define the attribute (lower box). The term expand and Create library buttons function as in the Create Fields interface above, except that the program operations initiated by the Create library button does not involve generation of a cross-term matrix. The upper Available attributes box shows attribute dictionaries already created and stored. Highlighting a dictionary name will bring up the attribute-specific terms in the Dictionary box, allowing the user to view and edit dictionary terms, as above. As with the Create Fields interface, the Create Attributes interface allows the user to edit, e.g., delete, selected attribute-specific terms, and delete entire attribute dictionaries.

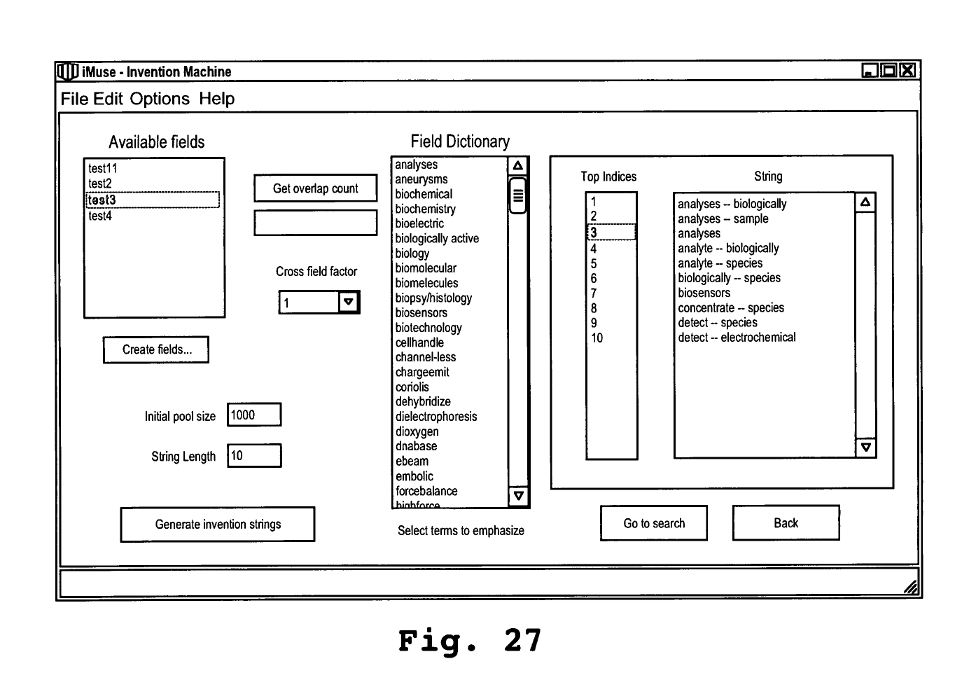

FIG. 27 shows the user interface for the Generate new strings module. The Available fields box at the upper left displays all of the field (class) dictionaries stored in the system. From this list, the user will select one or more dictionaries as a source of words for string generation. If only a single class is selected, only the words from that selected class dictionary are used for generating strings. If two or more classes are selected for inclusion in string generation, the generated strings will be composed of approximately equal-length substrings of terms, one substring for each selected class. The program will also calculate a combined cross-term matrix for the selected classes, as described in section L above. The matrix values in the combined cross-term matrix can be adjusted by a selected multiplication factor chosen from a menu of factors in the Cross-field factor box. Where two or more classes are selected, the user may also get a term overlap count between or among the classes by activating from the Get overlap count button. The overlap count will include all cross-class term matches between all pairs of selected classes. The Create fields button will return the user to the above interface.

The user may specify the initial number of random-term strings at the Initial pool size box, and total string length at the String length box. If more than one field has been selected for string generation, the program assigns each substring an approximate equal term length so that the total number of terms in all substrings is equal to the specified term length. The Generate invention strings button initiates program operation to generate highest-fittest strings.

The one or more high-fitness strings are assigned an index number, which is displayed in the Top indices box. Highlighting on any index will call up the terms for that strings, listed in alphabetical order in the String box at the right. As noted above in Sections K and L, a user may modify a string-generation operation in one of two ways. First, where multiple fields are used in string generation, the user can adjust the combined cross-term matrix values by changing the cross-field factor. Secondly, selected terms can be emphasized by highlighting one or more selected terms shown in the field dictionary, using the Select items to emphasize button. This operation multiplies each cross-term matrix value associated with a highlighted term by a fixed multiplier, e.g., 5, enhancing the likelihood that the highlighted terms will appear in the highest-fitness strings. The Go to search button sends a lighted- index string to the search module. The Back button in this and other interfaces sends the program back to the main-menu interface.

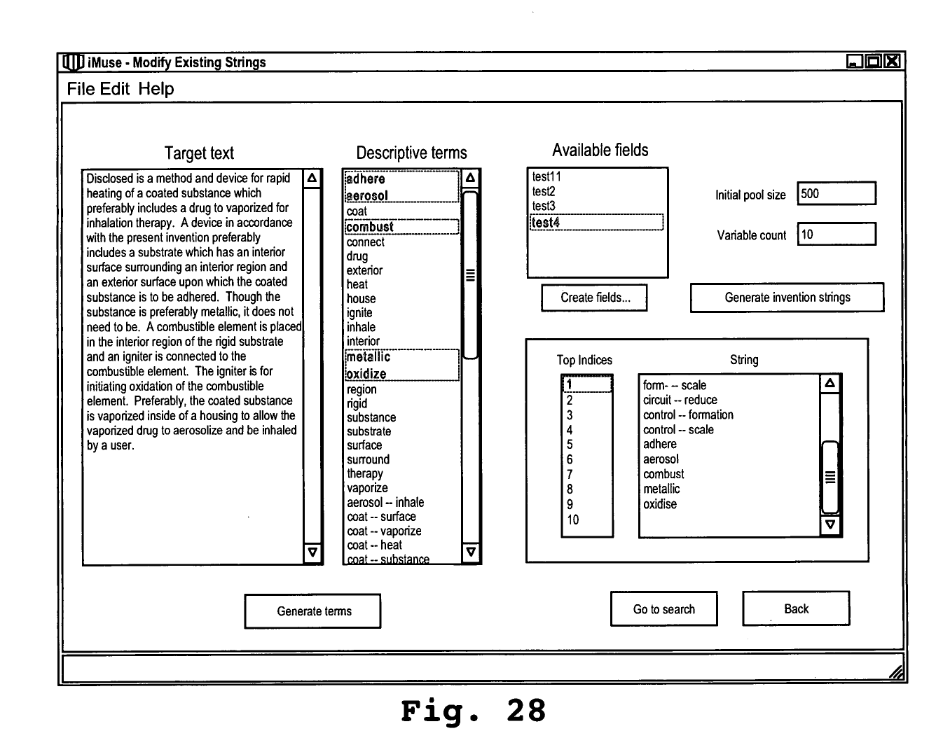

The user interface for modifying Existing strings is presented in FIG. 28. The Target text box at the left in the interface accepts a user-input text or string of terms, which can be either typed or pasted into the box. Once entered, the Generate terms box will initiate program operations to (i) process the text, as described above with respect to section D, and (ii) extract descriptive word and word-pair terms, as described in section F. The descriptive terms so extracted are then displayed in the Descriptive terms box.

String generation in this module involves first the user selecting those descriptive terms from the target text that are to appear in the generated string(s). This is done by highlighting each selected term in the Descriptive term box. The user then selects from the Available fields box, a field or class into which the text terms are to be expanded. The Initial pool size represents the number of strings manipulated, and the Variable count, the number of terms to appear in the variable portion of the evolving strings, as described in section L above. Both numbers are user selected. The Create Fields button will send the program back to the Create new fields interface, if the user desires to employ a filed not yet generated. The Generate invention strings button will initiate the string generation operation described in section L, yielding highest-fitness strings composed of the selected text terms and the variable-count number of terms from the selected field. As in the previously described interface, the program outputs one or more high-fitness strings, identified by indices in the Top indices box. Highlighting an index will display the string terms in the String box. The Go to search button will send a highlighted string to the search module, and the Back button will return the user to the main menu.

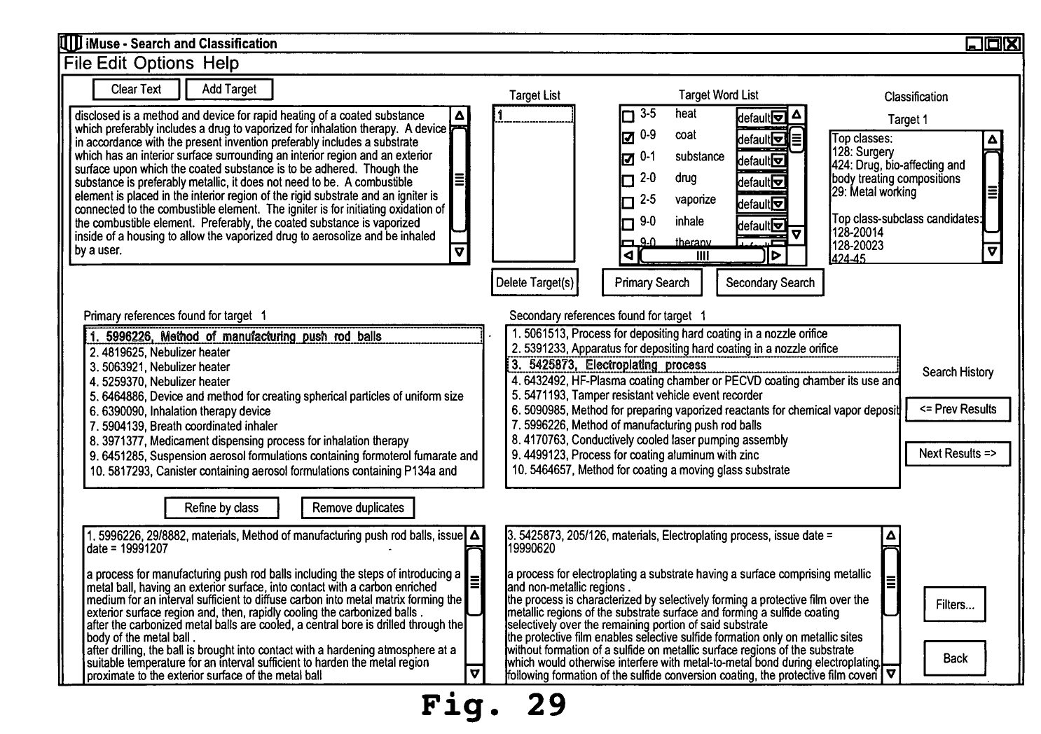

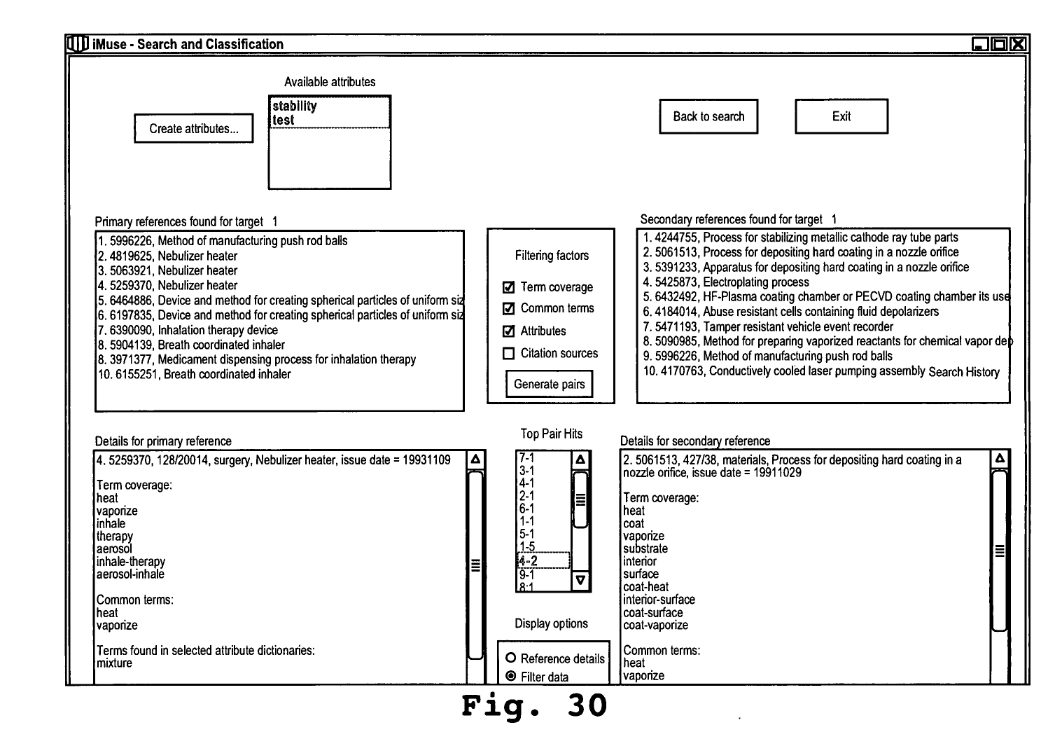

FIG. 29 shows a graphical interface in the system of the invention for use in text searching to identify primary and secondary groups of texts. The target text, that is, a string of terms, e.g., high-fitness terms from the modules above, or a description of the concept one wishes to generate and some of its properties or features, are entered in the text box at the upper left. By clicking on “Add Target,” the user enters this target in the system, identified as target in the Target List. The search is initiated by clicking on “Primary Search.” Here the system processes the target texts, identifies the descriptive words and word pairs in the text, constructs a search vector composed of these terms, and searches a large database, in this example, a database of about 1 million U.S. patent abstracts in various technical fields, 1976-present.

The program operates, as described above, to find the top-matched primary and secondary references, and these are displayed, by number and title, in the two middle text boxes in the interface. By highlighting one of these text displays, the text record, including patent number, patent classification, full title and full abstract are given in the corresponding text boxes at the bottom of the interface. The target text classification, based on statistical measures from the top-ranked primary texts, is displayed in the upper right box in the figure.

To refine the primary texts by class, the user would highlight a displayed patent having that class, and click on Refine by class. The program would then output, as the top primary hits, only those top ranked texts that also have the selected class. The Remove duplicate button removes any duplicate title/abstracts from the top-ten displayed texts.

The Target word list box in the interface show, for each word term, the number of times the word appears in the top ten primary and secondary texts. Thus, in the box shown, the word “heat” has a number occurrence of “3-5” meaning that the word has appeared in 3 of the top ten primary references, and of the top ten secondary references. A check mark by the word indicates that the word must appear in the secondary-search vector, as described above in section G.

To refine either the primary or secondary searches by word emphasis, the user would scroll down the words in the Target Word List until a desired word is found. The user then has the option, by clicking on the default box, to modify the word to emphasize, require, or ignore that word, and in addition, can specify at the left whether the word should be included in the secondary search (check mark). Once these modifications are made, the user selects either Primary search which then repeats the entire search with the modified word values, or Secondary search, in which case the program executes a new secondary search only, employing the modified search values.

The Previous results and Next results button scroll the interface date between earlier or later search results. The Filters button sends the program, and the text information data for the top ten primary and secondary searches, to the Filtering module and interface. The Back button returns the user to the main menu.

FIG. 30 shows the user interface for filtering and selecting paired texts. The primary and secondary texts from the previous search are displayed at the center two text boxes in the interface. By selecting one or more of the filters (the features filter is not shown here), the program will execute the selected filter steps and display the top text pairs in the Top Pair Hits box at the lower middle portion of the screen. This will display pairs of primary and secondary references whose details are shown in the two bottom text boxes. Thus, for example, by highlighting the pair “17-6” in the box, the details of the 17^{th} primary text and the 6^{th} secondary text are displayed in the two lower text boxes as shown.

When the attribute filter is selected, the user has the option of creating a new attribute or selecting an existing attribute shown in the Available attribute box. If the user elects to create a new attribute, the attribute interface shown in FIG. 26 is displayed from which the user can generate new attributes as described above.

The Generate Pairs button then selects pairs of top-ranked primary and secondary texts based on more or more of the specified filters, and the top- ranked pairs are displayed in the Top pair hits box. Thus, in the box shown, the pair “7-1” indicates a top-ranked pair that includes the top-scoring primary texts and the seventh-scoring secondary text. Text information about a highlighted pair is displayed in the two lower boxes in the interface. At the user's selection, the display may be either Reference details, e.g., text abstracts, or Filter data, that can include, as shown in the figure, text identification information, term coverage for the two texts, common terms, terms found in the attribute dictionary, and text-citation scores.

From the foregoing, it will be seen how various objects and features of the invention have been met. As noted in Section B, generating new concepts or inventions can be viewed as a series of selection steps, each requiring user information to make a suitable or optimal choice at each stage. This is illustrated by the bar graphs shown in FIGS. 1B and 2B for a human-generated invention. Since the present invention employs various text mining operations to assist in finding generating new combinations of text terms, and in locating primary (staring point) and secondary (modification) references, and in identifying optimal combinations of texts, the system can significantly reduce the information-input needed by an inventor to generate a new concept. The information difference is, as will now be appreciated, is supplied by various text-mining operations carried out by the system designed to (i) identify descriptive word and word-group terms in natural-language texts, (ii) find terms that tend to associate with one another in existing invention, (iii) locate pertinent texts, and (iv) generate pairs of texts based on various types of statistically significant (but generally hidden) correlations between the texts.

While the invention has been described with respect to particular embodiments and applications, it will be appreciated that various changes and modification may be made without departing from the spirit of the invention.

1. A computer-assisted method for generating candidate novel concepts related to one or more selected classes of concepts, comprising
(A) generating strings of terms composed of combinations of word and optionally, word-group terms that are descriptive of concept elements in such class(es),
(B) producing one or more high fitness strings by the steps of:
(B1) mating said strings to generate strings with new combinations of terms;
(B2) determining for each of said strings, a fitness score based on the application of a fitness metric which is related to one or both of the following:
(B2a) for pairs of terms in the string, the number occurrence of such pairs of terms in texts in a selected library of texts;
(B2b) for terms in the string, and for one or more preselected attributes, attribute-specific selectivity values of such terms,
(B3) selecting those strings having the highest fitness score, and
(B4) repeating steps (B1)-(B3) until a desired fitness-score stability is reached, and
(C) identifying one or more texts whose terms overlap with those of a high fitness string produced in step (B).

2. The method of claim 1, for use in generating novel invention concepts, wherein the one or more selected classes are technology-related classes, and the selected library of texts in (B2a) and the texts in (C) include patent abstracts or claims or abstracts from scientific or technical publications.

3. The method of claim 1, wherein step (A) includes the steps of:
(A1) constructing a library of texts related to each of the one or more selected classes,
(A2) identifying, for each of the selected classes, a set of word and/or word-group terms that are descriptive of that class, as evidenced by higher frequencies of occurrence of the terms in the library of texts from (A1) than in library of randomly selected texts, and
(A3) constructing combinations of terms from the set(s) of terms from
(A2) to produce strings of terms of a given number of terms.

4. The method of claim 1, wherein step (B) includes
(B1a) selecting pairs of strings, and
(B1b) randomly exchanging terms between the two strings in a pair.

5. The method of claim 1, wherein step (B1) includes
(B1a) selecting pairs of strings, and
(B1b) exchanging segments of strings between the two strings in a pair.

6. The method of claim 4 or 5, wherein step (B1) further includes
(B1c) randomly introducing a term substitution into a string of terms.

7. The method of claim 1, wherein step (B2) for determining fitness score for a string according to the number occurrence of groups of terms in texts in a library of concepts includes,
(B2ai) for each pair of terms in the string, determining a term-correlation value related to the number occurrence of that pair of terms in a selected library of texts,
(B2aii) adding the term-correlation values for all pairs of terms in the string.

8. The method of claim 7, wherein the selected library of texts includes texts from a plurality of different classes.

9. The method of claim 7, wherein the selected library of texts includes texts related to the one or more selected classes.

10. The method of claim 1, wherein step (B2) for determining fitness score for a string according to the selected values of one or more selected attributes includes,
(B2bi) for each term in the string, determining whether that term matches a term that is attribute-specific for a selected attribute;
(B2bii) assigning to each matched term, a selectivity value related to the occurrence of that term in the texts of a library of texts related to that attribute relative to the occurrence of the same term in a library of randomly selected texts, one or more different libraries of texts, and
(B2iii) adding the selectivity values for all of the matched terms in the string.

11. The method of claim 1, wherein step (B4) is repeated until the difference in a fitness score of one or more of the highest-score strings between successive repetitions of steps (B1)-(B3) is less than a selected value.

12. The method of claim 1, for use in for generating combinations of texts that represent candidate novel concepts related to two or more different selected classes, wherein
step (A) includes the steps of:
(A1) constructing a library of texts related to each of the two or more selected classes,
(A2) identifying, for each of the selected classes, a set of word and/or word-group terms that are descriptive of that class, as evidenced by higher frequencies of occurrence of the terms in the library of texts from (A1) than in a library of randomly selected texts,
(A3) constructing combinations of terms from each of the sets of terms from (A2) to produce class-specific subcombination strings of terms, each with a given number of terms; and
(A4) constructing combined strings from the class-specific subcombinations of strings from (A3), and
step (B1) includes the steps of
(B1a) selecting pairs of combined strings, and
(B1b) randomly exchanging terms or segments of strings between the associated class-specific subcombinations of terms in the pair of strings, and
step (B2) for determining fitness score for a string according to the number occurrence of groups of terms in texts in a selected library of concepts includes,
(B2ai) for each pair of terms within a class-specific subcombination of terms in the string, determining a term-correlation value related to the number occurrence of that pair of terms in a selected library of texts,
(B2aii) for each pair of terms within two class-specific subcombinations of terms in the string, determining a term-correlation value related to the number occurrence of that pair of terms in a selected library of texts, and
(B2aiii) adding the term-correlation values from (B2ai) and (B2aii) for all pairs of terms in the string.

13. The method of claim 1, wherein step (C) includes
(C1) searching a database of class-related texts, to identify a primary group of texts having highest term match scores with a first subset of the terms in said string,
(C2) searching a database of class-related texts, to identify a secondary group of texts having the highest term match scores with a second subset of said terms, where said first and second subsets are at least partially complementary with respect to the terms in said string,
(C3) generating pairs of texts containing a text from the primary group of texts and a different text from the secondary group of texts, and
(C4) selecting for presentation to the user, those pairs of primary and secondary texts that have highest overlap scores as determined from one or more of:
(C4a) overlap between descriptive terms in one text in the pair with descriptive terms in the other text in the pair;
(C4b) overlap between descriptive terms present in both texts in the pair and said list of descriptive terms;
(C4c) for one or more attributes associated with the target invention, the presence in at least one text in the pair of attribute-specific terms defined as having a substantially higher rate of occurrence in an attribute library composed in texts containing a word- and/or word-group term that is descriptive of that attribute, and
(C4d) a citation score related to the extent to which one or both texts in the pair are cited by later texts.

14. The method of claim 1, which further includes, following step (B), changing the fitness metric to produce a different fitness score for a given string, and repeating step (B) one or more times to generate different highest-score strings.

15. The method of claim 1, for generating combinations of texts that represent candidate novel concepts related to a specific concept, wherein step
(A) includes
(A1) identifying word and optionally, word-group terms that are descriptive of the specific concept,
(A2) identifying word and optionally, word-group terms that are descriptive of one or more selected classes of concepts,
(A3) constructing combinations of terms composed of (i) the terms identified in (A1) and (ii) permutations of terms from (A2) to produce strings of containing a given number of terms,
and wherein step (B) includes mating said strings to generate strings with (i) the same terms from (A1) and new combinations of the terms from (A2).

16. A computer-assisted method for generating combinations of word and optionally, word-group terms that represent candidate novel concepts related to one or more selected classes of concepts, comprising
(A) generating strings of terms composed of combinations of word and optionally, word-group terms that are descriptive of concept elements in such class(es), and
(B) producing one or more high fitness strings by the steps of:
(B1) mating said strings to generate strings with new combinations of terms;
(B2) determining for each of said strings, a fitness score based on the application of a fitness metric which is related to one or both of the following:
(B2a) for pairs of terms in the string, the number occurrence of such pairs of terms in texts in a library of texts;
(B2b) for terms in the string, and for one or more preselected attributes, attribute-specific selectivity values of such terms,
(B3) selecting those strings having the highest fitness score, and (B4) repeating steps (B1)-(B3) until a desired fitness-score stability is reached.

17. An automated system for generating combinations of texts that represent candidate novel concepts in one or more selected classes, comprising
(1) a computer,
(2) accessible by said computer, (a) a database of texts that include texts related to the one or more selected classes, (b) a words-records database of words and text identifiers containing those words, and
(3) a computer readable code which is operable, under the control of said computer, to perform the steps of claim 1.

18. The system of claim 17, wherein said code is operable to:
(A1) construct a library of texts from a selected class of concepts,
(A2) identify word and/or word-group terms that occur with higher frequency in the library of texts from (A1) than in a library of randomly selected texts, and
(A3) construct combinations of terms from (A2) to produce strings of terms of a given number of terms.

19. The system of claim 17, wherein said code is operable to construct a metric for determining a fitness score based on the number occurrence of pairs of terms in texts in a one or more selected libraries of texts, by determining the number occurrence of each pair of terms from step (A) in the one or more selected libraries of texts.

20. The system of claim 17, wherein said code is operable to construct a metric for determining a fitness score based the presence of terms that are attribute-specific for a selected attribute, by the steps of
(B3ci) employing one or more user-supplied attribute terms to construct an attribute-specific library;
(B3cii) identifying non-generic terms from said attribute library,
(B3ciii) determining, for each of the non-generic terms form (B3cii), an attribute-specific selectivity value related to the occurrence of that attribute term in the texts of the associated attribute library relative to the occurrence of the same term in one or more different libraries of texts, and
(B3civ) selecting those terms having selectivity values above a given threshold.

21. The system of claim 17, wherein said code is operable, in carrying out step (C) to
(C1) search a database of field-related texts, to identify a primary group of texts having highest term match scores with a first subset of the terms in said string,
(C2) search a database of field-related texts, to identify a secondary group of texts having the highest term match scores with a second subset of said terms, where said first and second subsets are at least partially complementary with respect to the terms in said string,
(C3) generate pairs of texts containing a text from the primary group of texts and a different text from the secondary group of texts, and
(C4) select for presentation to the user, those pairs of texts that have highest overlap scores as determined from one or more of:
(C4a) overlap between descriptive terms in one text in the pair with descriptive terms in the other text in the pair;
(C4b) overlap between descriptive terms present in both texts in the pair and said list of descriptive terms;
(C4c) for one or more attributes associated with the target invention, the presence in at least one text in the pair of attribute-specific terms defined as having a substantially higher rate of occurrence in an attribute library composed in texts containing a word- and/or word-group term that is descriptive of that attribute, and
(C4d) a citation score related to the extent to which one or both texts in the pair are cited by later texts.

22. Computer readable code for use with an electronic computer, a database of texts that include texts related to the one or more selected classes, and a words-records database of words and text identifiers containing those words, for generating combinations of texts that represent candidate novel concepts in one or more selected fields, and said code is operable, under the control of said computer, to perform the steps of claim 1.

23. The code of claim 22, which is operable to:
(A1) construct a library of texts from a selected class of concepts,
(A2) identify word and/or word-group terms that occur with higher frequency in the library of texts from (A1) than in a library of randomly selected texts, and
(A3) construct combinations of terms from (A2) to produce strings of terms of a given number of terms.

24. The code of claim 22, which is operable to construct a metric for determining a fitness score based on the number occurrence of pairs of terms in texts in a one or more selected libraries of texts, by determining the number occurrence of each pair of terms from step (A) in the one or more selected libraries of texts.

25. The system of claim 22, which is operable to construct a metric for determining a fitness score based the presence of terms that are attribute- specific for a selected attribute, by the steps of
(B3ci) employing one or more user-supplied attribute terms to construct an attribute-specific library;
(B3cii) identifying non-generic terms from said attribute library,
(B3ciii) determining, for each of the non-generic terms form (B3cii), an attribute-specific selectivity value related to the occurrence of that attribute term in the texts of the associated attribute library relative to the occurrence of the same term in one or more different libraries of texts, and
(B3civ) selecting those terms having selectivity values above a given threshold.

26. The system of claim 22, which is operable, in carrying out step (C) to
(C1) search a database of field-related texts, to identify a primary group of texts having highest term match scores with a first subset of the terms in said string,
(C2) search a database of field-related texts, to identify a secondary group of texts having the highest term match scores with a second subset of said terms, where said first and second subsets are at least partially complementary with respect to the terms in said string,
(C3) generate pairs of texts containing a text from the primary group of texts and a different text from the secondary group of texts, and
(C4) select for presentation to the user, those pairs of texts that have highest overlap scores as determined from one or more of:
(C4a) overlap between descriptive terms in one text in the pair with descriptive terms in the other text in the pair;
(C4b) overlap between descriptive terms present in both texts in the pair and said list of descriptive terms;
(C4c) for one or more attributes associated with the target invention, the presence in at least one text in the pair of attribute-specific terms defined as having a substantially higher rate of occurrence in an attribute library composed in texts containing a word- and/or word-group term that is descriptive of that attribute, and
(C4d) a citation score related to the extent to which one or both texts in the pair are cited by later texts.
